(19) United States
(12) Patent Application Publication
(10) Pub. No.: US 2020/0135033 A1
(43) Pub. Date: Apr. 30, 2020

(54) SYSTEMS AND METHODS FOR MANAGING PLATOONS

(71) Applicant: Peloton Technology, Inc., Mountain View, CA (US)

(72) Inventors: Joshua P Switkes, Mountain View, CA (US); Brian Smartt, Los Gatos, CA (US); Joyce Tam, Pleasanton, CA (US); Oliver Bayley, Pacifica, CA (US); Marc Ryan Mazonni, Los Gatos, CA (US); Wayne Wright, San Jose, CA (US)

(73) Assignee: Peloton Technology, Inc., Mountain View, CA (US)

(21) Appl. No.: 16/174,024

(22) Filed: Oct. 29, 2018

(51) Int. Cl. G08G 1/00; G08G 1/127

(52) U.S. Cl. CPC G08G 1/22; G08G 1/127; G08G 1/207

(57) ABSTRACT

Systems and methods for increasing the efficiency of vehicle platooning systems are described. In one aspect, data associated with two or more vehicles is received by a system. The data received by the system may be used by a system to track and analyze fleet locations, activities, and fuel efficiency among other attributes. In some examples, fleets management systems may provide users with granular information regarding hundreds of vehicles and information about their platooning systems. Systems and methods described herein also indicated how fleet management and analysis systems can be used to create safer and more fuel-efficient trips.

### BACKGROUND

Enabling a vehicle to follow closely behind one vehicle safely through partial or full automation has significant fuel savings, safety, and/or labor savings benefits, but is generally unsafe when a driver tries to do this manually. Presently, during normal driving, vehicle motion is controlled either manually, by a driver, or by convenience systems, such as cruise control or adaptive cruise control. The various types of cruise control systems control vehicle speed to make driving more pleasurable or relaxing, by partially automating the driving task. Some of these systems use range sensors and/or vehicle sensors to control the speed to maintain a constant headway relative to the leading vehicle (also referred to herein as a front vehicle). In general, these cruise control systems provide minimal added safety, and do not have full control of the vehicle (in terms of being able to fully brake or accelerate).

Driver control does not match the safety performance of even current systems, for several reasons. First, a driver cannot safely maintain a close following distance. In fact, the relatively short distances between vehicles necessary to get any measurable fuel savings results in an unsafe condition if the vehicle is under driver control, thereby risking a costly and destructive accident. Further, the driver is not as capable of maintaining an optimal headway as an automated system is. In fact, a driver trying to maintain a constant headway often causes rapid and large changes in command (accelerator pedal position for example), resulting in a loss of efficiency.

Thus, it would be desirable to have reliable and economical semi-automated vehicular convoying/platooning systems which enable vehicles to follow closely together in a safe, efficient, convenient manner.

Moreover, it is important to build an infrastructure that supports such technologies. Currently, there is a need in the industry to optimize safety and fuel, and comprehensively monitor, communicate with, and in some cases control platooning vehicles.

### SUMMARY

The systems and methods comprising various aspects of the disclosure described herein provide for more efficient management of multiple vehicles. For example, without limitation, aspects of the present invention enable methods for receiving locations of a platoonable vehicle from the platoonable vehicle, and receiving locations of a second platoonable vehicle from the second platoonable vehicle. An electronic device may cause a display to show information about the two vehicles including their location, and distances that the vehicles traveled while platooning.

In another aspect, without limitation, a system may determine what platooning information to display, which may include operations performed by a network operations center (NOC), a processor, and memory. The NOC may receive location information about two vehicles and transmit that information to a terminal which can display the location information, and routes that the two vehicles traveled among other information.

In still another aspect, without limitation, a method for receiving information from a vehicle at an electronic device is described. The method may include receiving information about a location of a vehicle, the route a vehicle travels, and where on the route the vehicle has platooned. The display may also include a map including information indicating where the vehicle platooned.

It will be appreciated by those skilled in the art that the various features of the present disclosure can be practiced alone or in combination.

These and other features of the present disclosure will be described in more detail below in the detailed description of the disclosure and in conjunction with the following figures.

### BRIEF DESCRIPTION OF THE DRAWINGS

In order to describe the various aspects of the present disclosure, some detailed description now will be provided, by way of illustration, with reference to the accompanying drawings, in which:

FIG. 1 illustrates a diagram of a platooning system, in accordance with some embodiments;

FIG. 2 illustrates a block diagram of a platooning system, in accordance with some embodiments;

FIG. 3 illustrates a block diagram of a system including an electronic control unit, in accordance with some embodiments;

FIG. 4 illustrates an example dashboard, in accordance with some embodiments;

FIGS. 5A-5F illustrate example maps, in accordance with some embodiments;

FIGS. 6A-6B illustrate example user interfaces, in accordance with some embodiments;

FIG. 7 illustrates an example map, in accordance with some embodiments;

FIGS. 8A-8D illustrate example user interfaces, in accordance with some embodiments;

FIGS. 9A-9B illustrate example user interfaces including vehicle attributes, in accordance with some embodiments;

FIGS. 10A-10B illustrate example user interfaces including vehicle attributes, in accordance with some embodiments;

FIGS. 11A-11B illustrate example user interfaces including vehicle attributes, in accordance with some embodiments;

FIG. 12 illustrates a flow chart of an example process, in accordance with some embodiments; and

FIG. 13 illustrates an example computing system, in accordance with some embodiments.

### DETAILED DESCRIPTION

The present invention will now be described in detail with reference to several embodiments thereof as illustrated in the accompanying drawings. In the following description, numerous specific details are set forth in order to provide a thorough understanding of embodiments of the present invention, including the description of a plurality of different aspects of the invention, including, in some cases, one or more alternatives. It will be apparent to those skilled in the art that the invention can be practice without implementing all of the features disclosed herein. Further, although many embodiments included in the instant application are related to the concept of platooning, it should be appreciated that many broader applications are envisioned.

Without limitation, the Applicant has proposed various vehicle platooning systems in which a second, and potentially additional, vehicle(s) is/are automatically, or semi-automatically controlled to closely follow a lead/front vehicle in a safe manner. By way of example, U.S. patent application Ser. Nos. 15/605,456, 15/607,902; 13/542,622 and 13/542,627; U.S. Provisional Patent Application Nos. 61/505,076, 62/377,970 and 62/343,819; and PCT Patent Application Nos. PCT/US2014/030770, PCT/US2016/049143, PCT/US2018/41684, and PCT/US2016/060167 describe various vehicle platooning systems in which a trailing vehicle (also referred to herein as a rear vehicle) is at least partially automatically controlled to closely follow a designated lead vehicle. Each of these earlier applications are incorporated herein by reference.

One of the goals of platooning is typically to maintain a desired gap between the platooning vehicles and/or a desired relative speed and/or time headway (e.g., a gap may refer to a distance, a headway, or both). Thus, it should be appreciated that, herein, any reference to the term “gap” could refer to a distance, a headway, or both. Further, while the term “maintain” is used throughout this disclosure, maintaining may mean staying within a gap (distance/headway), staying at a gap, and/or keeping at least a certain gap. Further, a desired gap may include a relative distance, time headway, and/or angle/offset. A longitudinal distance and/or time headway is frequently referred to herein as a “target gap”. That is, it is desirable for the trailing vehicle (e.g., a rear vehicle) to maintain a designated gap relative to a specific vehicle (e.g., a lead vehicle). The vehicles involved in a platoon will typically have sophisticated control systems suitable for initiating a platoon, maintaining the gap under a wide variety of different driving conditions, and gracefully dissolving (e.g., ending) the platoon as appropriate. It should be appreciated that herein, a gap may refer to a distance, a time headway, or either.

As described herein, the concept of platooning, also known as convoying, is still in its infancy. Academics have toyed with the concept over the last few decades, but to date there are no commercial systems on the road where a vehicle is at least partially controlled by another vehicle via a vehicle-to-vehicle connection (V2V). The benefits provided by such systems are obvious. Namely, the safety provided by these systems is far greater than a system where a rear vehicle doesn't begin to slow down until its radar or LIDAR sensors determine that a lead vehicle is slowing down, such as with some adaptive cruise control systems. Further, by being able to follow another vehicle at a close distance, in some cases both a rear vehicle and a front vehicle may experience significant fuel savings.

As platoonable vehicles (e.g., vehicles capable of platooning or any type of following based on V2V communication, whether directly following each other, offset in different lanes, and/or with one or more vehicles between them) begin to roll out of the labs and into commercial production, their adoption faces significant challenges. For example, original equipment manufacturers (OEMs), fleets (e.g., freight hauling companies), and other customers of platooning systems require systems to manage their vehicles.

Herein, systems and methods for such a system are described.

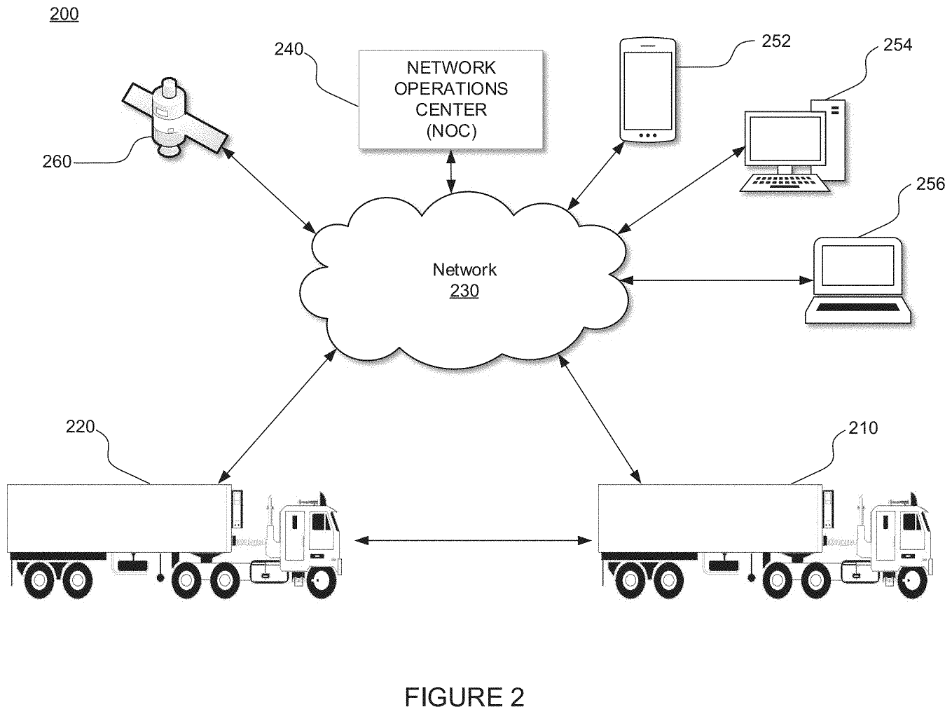

In various embodiments, a system for producing, transmitting, analyzing, and presenting information associated with at least one vehicle is described. For example, a web application may be accessed at a terminal and provide tremendous amounts of information associated with vehicles in their fleet. This information may include locations and attributes associated with platoonable vehicles (e.g., vehicles capable of platooning). In an example embodiment, a platooning electronic controller (also referred to as a PECU, platooning controller, etc.) may receive information including the location of a vehicle in which the PECU is located (e.g., the PECU may receive location information from a GPS system located in/on/at the vehicle). This location information may be transmitted via a network including a network operations center (NOC, also known as a network operations cloud as shown in FIG. 2), and then/also be received at a terminal such as a laptop or desktop computer. From that terminal, a user may make decisions about the fleet based on the information received from the vehicles and/or additional sources (e.g., weather and/or traffic information services).

In some embodiments, information about a distance that two vehicles have platooned may be displayed on a screen. In some instances, an amount of fuel used, an amount of fuel saved by platooning, and/or an amount of money saved or estimated to be saved by platooning may be displayed by systems and methods described herein. In some embodiments of the system, a map may be displayed which indicates whether, when, and/or where certain events occurred such as the engagement or disengagement of a platoon. In some embodiments, a system may include buttons or other widgets that can be pressed/activated to include or exclude information in a manner that is easy to view on a screen. In some embodiments, a system may provide a user with the ability to sort information by dates, such as by providing a user with a calendar (which, for instance, can change sizes according to user preferences and/or an amount of screen real estate). In some embodiments, a system can show a location where a platoon ended (e.g., disengaged), and how many platoons ended/disengaged at or in an area near that location (e.g., a busy highway intersection where platooning is difficult). In some embodiments, a system may automatically, or allow a user to create a geofence wherein vehicles can or cannot platoon. For instance, the area may be determined based on how many platoons ended/disengaged at or near a location. Moreover, in some embodiments a system may automatically, or allow a user, to: cause vehicle(s) to pair/unpair; cause vehicle(s) to engage (start a platoon by drawing-in) and/or disengage (end a platoon by dissolving (increasing a gap between vehicles and ending a platoon)); control latitudinal and longitudinal commands (e.g., operate a vehicle remotely); authorize and/or deauthorize vehicle(s) from platooning, etc.

In addition to location information, a NOC, terminal, and/or a vehicle—such as a Class 8 truck—may include one or more devices (such as a PECU) that can produce, gather, transmit, analyze, and/or present information including, but not limited to: a distance the vehicle traveled within a certain amount of time (e.g., in a day); whether, where, and/or when the vehicle is/was paired and/or not paired with one or more additional vehicles; whether, where, and/or when a vehicle is/was authorized to platoon; whether, where, and/or when a vehicle is/was platooning; whether, where, and/or when a device in a vehicle was receiving/transmitting voice communications; whether, where, and/or when a vehicle did not have authorization to platoon; whether, where, and/or when a vehicle was not platooning; whether, where, and/or when a vehicle is/was receiving information from a NOC; whether, where, and/or when a vehicle is/was platooning with another vehicle while in a different lane of a road from the other vehicle; whether, where, and/or when a platoon was dissolved due to a cut-in (e.g., where a non-platooning vehicle entered the area between two vehicles platooning with each other and caused the platoon to dissolve (e.g., increase a gap between two or more vehicles and end the platoon)); whether, where, and/or when a controller in the vehicle faulted (e.g., a PECU); whether, where, and/or when a driver input device (DID) faulted; whether, where, and/or when at least a portion of a braking system faulted; whether, where, and/or when a link between two paired and/or platooning vehicles faulted; whether, where, and/or when a vehicle incorrectly engaged (e.g., started a platoon (e.g., began to draw-in)) with another vehicle; whether, where, and/or when a vehicle incorrectly dissolved a platoon; whether, where, and/or when a vehicle is/was taken over by a driver (e.g., when a driver took control of a vehicle which may cause a platoon to dissolve); whether, where, and/or when a vehicle is/was connected to an LTE, 4G, and/or 5G network; and whether, where, and/or when a vehicle accelerated/decelerated incorrectly; whether, where, and/or when a dissolve was not acknowledged by a PECU.

Moreover still, in various embodiments information associated with a vehicle may be produced, gathered, transmitted, analyzed, and/or presented by a system including, but not limited to a/an: position, latitude, longitude, altitude, heading, speed, longitudinal and lateral acceleration, relative angle, type of load (e.g., type of materials a vehicle is carrying), brake status, brake pressure, path history, path projection, travel plans, vehicle size, vehicle type, brake type, current operating mode (autonomous or manual), map data, traffic information, GPS augmentation information (e.g., delays from infrastructure), wheel speed, wheel torque, gross torque, net torque, wind, rain, music, video, infotainment system, suspension, axle weight(s), transmission status (e.g., what gear the vehicle is in, what gear the vehicle was in, what gears the vehicle transferred from and to (e.g., fifth gear to fourth gear)), previous transmission status, hybrid vehicle drivetrain (e.g., a parallel hybrid or an electric hybrid), electric motor, battery, super charger, electronic throttle control, throttle pedal, brake pedal, power steering, adaptive cruise control, a blowout, interior lighting, exterior lighting, retarder, anti-lock brakes, emergency braking, engine governor, powertrain, gear ratio, wheel size, wheel type, trailer length, trailer type, trailer height, amount of trailers, trailer position, current trailer position, past trailer position, tractor type, tractor height, transceiver type, current fuel, next determined stop, projected miles remaining until fuel tanks are empty, malfunctions, turn signals, LIDAR, radar, ultrasonic sensors, road surface, wheel angle, tire pressure, tire tread depth, cabin temperature, engine temperature, trailer interior temperature, camera, fleet of vehicles, NOC, computer vision, other vehicle traveling in the same direction, other vehicle traveling in an opposite direction, and intervening traffic (e.g., cut-ins, also referred to as the situation when a vehicle enters an area between a lead vehicle and a rear vehicle).

In some embodiments, systems and methods described herein may be presented on a device that is also capable of logging driver information (e.g., an electronic logging device which may log a driver's drive time), which may be part of a standalone device (e.g., a tablet, smart phone). In various embodiments, an electronic logging device may incorporate functionality from systems described herein (e.g., receive data from a NOC), or vice-versa. For example, an electronic logging device may also display the amount of time a driver was platooning, paired, and/or authorized to platoon. Further, an electronic logging device may include a social-network-type system to allow drivers to rendezvous/meet other drivers that may have similar utilization ratios, destinations, fuel economy, etc.

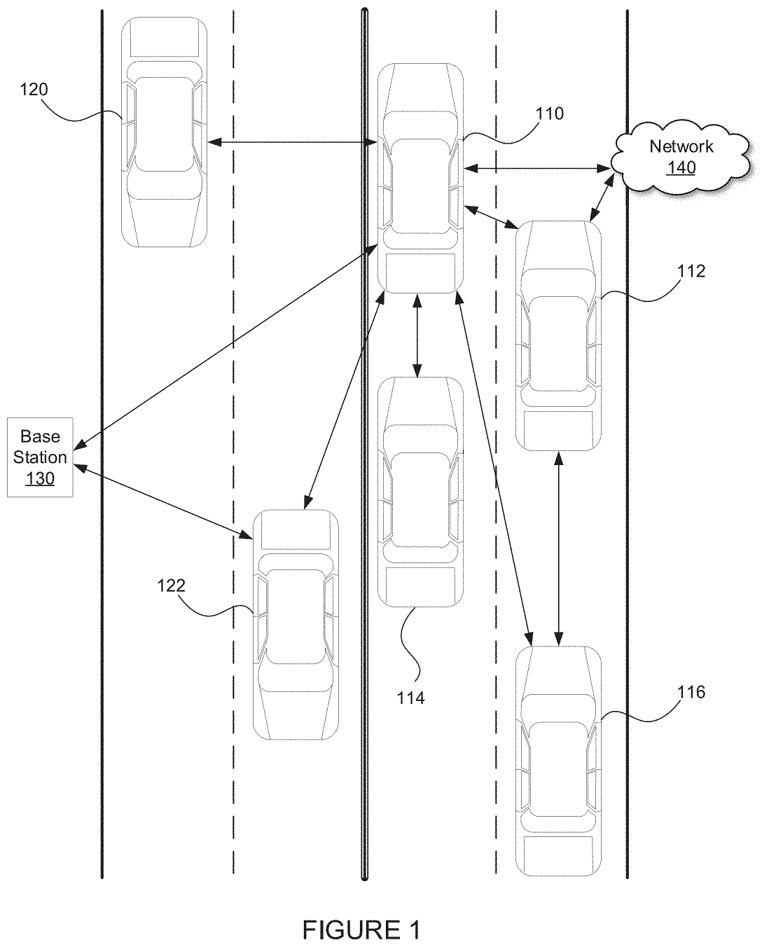

FIG. 1 illustrates a diagram of vehicles transmitting data, in accordance with some embodiments. FIG. 1. depicts multiple vehicles 110, 112, 114, 116, 120, and 122. FIG. 1 also depicts a base station 130 and a network 140. In various embodiments, vehicle 110 may transmit data (also referred to as information) to other vehicles 112, 114, 116, 120, and 122 directly, via base station 130, and/or via network 140. Vehicle 110 may also receive data from other vehicles 112, 114, 116, 120, and 122 directly, via base station 130, and/or via network 140. In some embodiments, a vehicle (e.g., vehicle 112) may retransmit information received from a first vehicle (e.g., vehicle 110) to another vehicle (e.g., vehicle 116) with or without additional information (e.g., information generated at vehicle 112 in addition to information received from vehicle 110).

In various embodiments, vehicles 110, 112, 114, 116, 120, and 122 may be configured to platoon, and may platoon with one another. In some embodiments, vehicles may transmit and/or receive data (e.g., to a NOC and/or fleet management system, etc.) including, but not limited to data indicating: whether they are available to platoon; whether they are platooning; whether a platoon they were part of dissolved; what direction they are traveling; what direction they are predicted (e.g., predetermined/planning on/suggested) to be traveling on for a particular period of time; when they are expected to stop (e.g., predetermined to stop, planning on stopping, suggested stopping time); where they plan on stopping; what route(s) they plan to travel (e.g., a route suggested and/or determined by a system, a route determined by a navigation/mapping system based on their destination such a system may be a rendezvousing system, a fleet management system, a navigation system, etc.); what type of platooning system they are equipped with; how many hours they have been on the road; weather they are capable of following the leader (e.g., if one or more vehicles can platoon without a driver); whether they are capable of being the leader in a follow-the-leader system; whether the vehicle is fully autonomous (e.g., capable of level 4 according to the SAE classification system); how much fuel they have saved; how much money they have saved; an area they are allowed to travel within; an area they are not allowed to travel outside of; whether they are capable of platooning on city streets; whether they are only capable of platooning on a highway; whether they are capable of platooning on non-public roads; whether they are capable of platooning in a particular construction site, mine, forest, etc.; and whether other attributes associated with a vehicle's account allows them to platoon. As should be understood, one or more of these attributes may be used to determine whether a vehicle can platoon with one or more additional vehicles, and whether a vehicle should platoon with one or more additional vehicles. It is contemplated that in some embodiments, a system may rank one or more vehicles with which a vehicle should platoon. In such an embodiment, if a target vehicle (e.g., a vehicle with a high ranking) that a first vehicle attempts to platoon with platoons with second vehicle before the first vehicle is able to platoon with the target vehicle, then the first vehicle may select another (e.g., the next) ranked vehicle that the system would like it to (e.g., determines that it should attempt to) platoon with.

In addition to these factors, other information that a vehicle may transmit and/or receive may include data including, but not limited to data associated with a/an: position, latitude, longitude, altitude, heading, speed, longitudinal and lateral acceleration, relative angle, type of load (e.g., type of materials a vehicle is carrying), brake status, brake pressure, path history, path projection, travel plans, vehicle size, vehicle type, brake type, current operating mode (autonomous or manual), map data, traffic information, GPS augmentation information (e.g., delays from infrastructure), wheel speed, wheel torque, gross torque, net torque, wind, rain, music, video, infotainment system, suspension, axle weight(s), transmission status (e.g., what gear the vehicle is in, what gear the vehicle was in, what gears the vehicle transferred from and to (e.g., fifth gear to fourth gear)), previous transmission status, hybrid vehicle drivetrain (e.g., a parallel hybrid or an electric hybrid), whether a vehicle has an electric motor, battery, electronic throttle control, throttle pedal, brake pedal, power steering, adaptive cruise control, a blowout, interior lighting, exterior lighting, retarder, anti-lock brakes, emergency braking, engine governor, powertrain, gear ratio, wheel size, wheel type, trailer length, trailer type, trailer height, amount of trailers, trailer position, current trailer position, past trailer position, tractor type, tractor height, transceiver type, current fuel, next determined stop, projected miles remaining until fuel tanks are empty, malfunctions, turn signals, LIDAR, radar, ultrasonic sensors, road surface, wheel angle, tire pressure, cabin temperature, engine temperature, trailer interior temperature, camera, fleet of vehicles, NOC, computer vision, other vehicle traveling in the same direction, other vehicle traveling in an opposite direction, and intervening traffic (e.g., cut-ins, also referred to as the situation when a vehicle enters an area between a lead vehicle and a rear vehicle). This information can be used by one or more vehicles, systems, fleets, etc. to determine whether a vehicle may platoon with another vehicle and/or to determine the best vehicle with which a vehicle may platoon. Again, it is contemplated that in some embodiments, a system may rank one or more vehicles with which a vehicle should platoon, and this ranking may be based on vehicle attributes described above. In such an embodiment, if a target vehicle that a first vehicle wishes to platoon with platoons with another vehicle before the first vehicle is able to platoon with the target vehicle, then the first vehicle may move to another (e.g., the next) ranked vehicle that the system would like it to (e.g., determines that it should attempt to) platoon with.

It should be understood that, herein, when a system determines a rendezvous location and/or rendezvous time, that any of these attributes/information/data may be used alone or in combination to determine: whether two or more vehicles can platoon together, a rendezvous location, a rendezvous time, etc.

FIG. 2 illustrates an example system 200 including two vehicles capable of platooning and associated communication links. Vehicles 210 and 220 are depicted by trucks which are capable of platooning, and can communicate with each other directly or through network 230. Direct communication between two vehicles can occur wirelessly via Dedicated Short Range Communications (DSRC) (e.g., the IEEE 802.11p protocol), which is a two-way short to medium range wireless communications technology that has been developed for vehicle-to-vehicle (V2V) communications. Of course, other communications protocols and channels may be used in addition to or in place of a DSRC link. For example, the inter-vehicle communications may additionally or alternatively be transmitted over a cellular communications channel such as 4G LTE Direct, 5G, a Citizen's Band (CB) Radio channel, one or more General Mobile Radio Service (GMRS) bands, one or more Family Radio Service (FRS) bands, Wi-Fi, Zigbee and/or any other now existing or later developed communications channels using any suitable communication protocols either alone or in combination.

FIG. 2 also includes a network operations center (NOC) 240. NOC 240 may include one or more locations from which network monitoring, control, and/or management may be exercised over a communication network (e.g., a NOC may be located in the cloud/a multi-tenant environment). NOC 240 can oversee a complex network of vehicles, satellite communications, cellular networks, web applications, and/or management tools. Users of NOC 240 may be responsible for monitoring one or more networks, sub-networks, fleets of vehicles, and/or sub-fleets of vehicles that may require special attention to avoid degraded service. For example, NOC 240 may receive information about various vehicles 210 and 220 such as their locations and attributes, run various programs based on the received information, and send information back to vehicles 210 and 220, including indicating whether they are allowed to platoon.

In addition to NOC 240, client devices 252 (e.g., a smartphone or tablet), 254 (e.g., a desktop computer or terminal), and 256 (e.g., a laptop computer or terminal) may be used to send and/or receive information about vehicles 210 and 220, NOC 240, or information from canonical sources such as the Internet (e.g., Google Maps or another online map provider, a traffic provider, a weather provider, etc.). Client devices can be used to view attributes of vehicles 210 and 220 such as their location, an estimate of their weight, their speed, an amount of engine torque, amount of applied break, a destination, etc.

FIG. 2 also includes a satellite 260, which can send signals to network 230, NOC 240, and/or vehicles 210 and 220. Satellite 260 may be part of a satellite navigation system such as a global navigation satellite system (GNSS). GNSSs include the United States's Global Positioning System (GPS), Russia's GLONASS, China's BeiDou Navigation Satellite System, and the European Union's Galileo. Based on information sent from satellite 260, systems described herein can determine locations of vehicles 210 and 220.

Of course, it should be appreciated that the system described in FIG. 2 is only an example, and that many other configurations may exist. For example, a NOC may assist with the monitoring and control of hundreds or thousands of vehicles, and many types of web applications may exist.

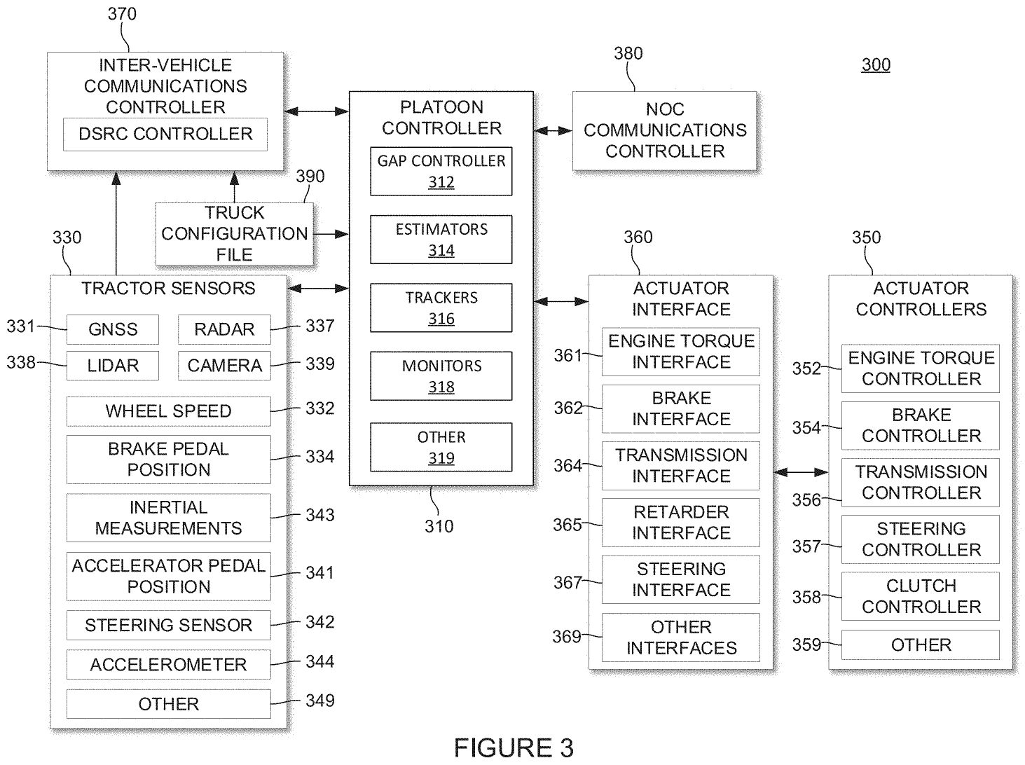

FIG. 3 illustrates and example system 300 including a platoon controller 310 (also referred to as a platoon electronic control unit, a platoon ECU, or a PECU). As described throughout this disclosure, a wide variety of configurations may be used to implement platooning systems described herein. The specific controller design can vary based on the level of automation contemplated for the controller, as well as the nature of and equipment available on the host vehicles participating in the platoon. FIG. 3 illustrates components of one possible configuration.

FIG. 3 diagrammatically illustrates a vehicle control architecture that can be suitable for use with platooning tractor-trailer trucks. The specific controller, or platooning ECU, illustrated is primarily designed for use in conjunction with a platooning system in which both vehicles include an active driver. The driver of the lead vehicle being fully responsible for control of the lead vehicle. In some embodiments the driver of the rear vehicle may be responsible for steering the rear vehicle, but the platoon controller 310 is primarily responsible for controlling the rear vehicle's torque and braking requests during active platooning. However, as discussed herein, it should be appreciated that generally similar control schemes can be used in systems which contemplate more automated control of one or both of the platoon partners or which utilize vehicle control commands other than or in addition to torque and braking requests.

In the example embodiment illustrated in system 300, a platoon controller 310, receives inputs from a number of sensors 330 on the tractor and/or one or more trailers or other connected units, and a number of actuator controllers 350 (also referred to as electronic control units or ECUs) arranged to control operation of the tractor's powertrain and other vehicle systems. An actuator interface 360 may be provided to facilitate communications between the platoon controller 310 and the actuator controllers 350. In some embodiments, one or more of the actuator interfaces 360 may be included in one or more of the actuator controllers 350 (e.g., an actuator interface may be included in an ECU). Platoon controller 310 also interacts with an inter-vehicle communications controller 370 (also referred to as an inter-vehicle communications ECU) which orchestrates communications with the platoon partner and a NOC communications controller 380 (also referred to as a NOC communication ECU) that orchestrates communications with a NOC. The vehicle also may have selected configuration files 390 that include known information about the vehicle.

Some of the functional components of the platoon controller 310 include gap controller 312, a variety of estimators 314, one or more partner vehicle trackers 316 and various monitors 318. In many applications, the platoon controller 310 will include a variety of other components 319 as well.

Some of the sensors utilized by platoon controller 310 may include GNSS unit 331, wheel speed sensors 332, inertial measurement devices 334, radar unit 337, lidar unit 338, cameras 339, accelerator pedal position sensor 341, steering wheel position sensor 342, brake pedal position sensor 343, and various accelerometers 344. Of course, not all of these sensors will be available on all vehicles involved in a platoon and not all of these sensors are required in any particular embodiment. A variety of other sensors 349 (now existing or later developed or commercially deployed) may be additionally or alternatively be utilized by platoon controller 310 in other embodiments.

Many (but not all) of the described sensors, including wheel speed sensors 332, radar unit 337, accelerator pedal position sensor 341, steering wheel position sensor 342, brake pedal position sensor 343, and accelerometer 344 are relatively standard equipment on newer trucks (tractors) used to pull semi-trailers. However, others, such as GNSS unit 331 and lidar unit 338 (if used) are not currently standard equipment on such tractors or may not be present on a particular vehicle and may be installed as needed or desired to help support platooning.

FIG. 3 also illustrates various actuator controllers 350. It should be understood that, in various embodiments, some or all types of controllers may be referred to interchangeably as electronic control units (ECUs). It should, however, be understood that some ECUs may control actuators, some ECUs may control communications, some ECUs may monitor sensors, and some may perform any combination thereof. Thus, it should be appreciated that the system shown in FIG. 3 is merely one of a wide variety of systems that may be used to control platooning.

Some of the vehicle actuator controllers 350 that platoon controller 310 may direct at least in part include engine torque controller 352; brake controller 354; transmission controller 356; steering/automated steering controller 357; and clutch controller 358. Of course, not all of these actuator controllers will be available or are required in any particular embodiment and it may be desirable to interface with a variety of other vehicle actuator controllers 359 that may be available on the vehicle as well. Therefore, it should be appreciated that the specific actuator controllers 350 directed or otherwise utilized by the platoon controller on any particular controlled vehicle may vary widely. Further, the capabilities of any particular actuator controller (e.g. engine torque controller 352), as well as its interface (e.g., the nature and format of the commands, instructions, requests and messages it can handle or generate) will often vary with the make and model of that particular actuator controller. Therefore, an actuator interface 360 is preferably provided to translate requests, commands, messages and instructions from the platoon controller 310 into formats that are appropriate for the specific actuator controller hardware and software utilized on the controlled vehicle. The actuator interface 360 also provides a mechanism for communicating/translating messages, commands, instructions and requests received from the various actuator controllers back to the platoon controller 310. In some embodiments, an appropriate actuator interface may be provided to interact with each of the specific vehicle controllers utilized. In various embodiments, this may include one or more of: an engine torque interface 361; a brake interface 362; a transmission interface 364; a retarder interface 365; a steering interface 367; and/or any other appropriate controller interface 369. In some embodiments, various controllers may be combined (e.g., in the case of a chassis controller, or an engine ECU that also controls a retarder—which may obviate the need for a retarder ECU).

Large trucks and other heavy vehicles frequently have multiple systems for “braking” the truck. These include the traditional brake system assemblies mounted in the wheels of the vehicle—which are often referred to in the industry as the “foundation brakes.” Most large trucks/heavy vehicles also have a mechanism referred to as a “retarder” that is used to augment the foundation brakes and serve as an alternative mechanism for slowing the vehicle or to help prevent the vehicle from accelerating down a hill. Often, the retarder may be controlled by the engine torque controller 352 and in such embodiments, the retarder can be controlled by sending appropriate torque commands (which may be negative) to engine torque controller 352. In other embodiments a separate retarder controller (not shown) may be accessible to, and therefore directed by, platoon controller 310 through an appropriate retarder interface 365. In still other embodiments, the platoon controller 310 may separately determine a retarder command that it sends to the actuator interface 360. In such embodiments the actuator interface will interpret the retard command and pass on appropriate retardation control commands to an Engine ECU or other appropriate vehicle controller.

The communications between vehicles may be directed over any suitable channel and may be coordinated by inter-vehicle communications controller 370. As described above, the DSRC protocol may work well.

The specific information transmitted back and forth between the vehicles may vary widely based on the needs of the controllers. In various embodiments, the transmitted information may include the current commands generated by the platoon controller 310 such as requested/commanded engine torque, and/or requested/commanded braking deceleration 382. They may also include steering commands, gear commands, etc. when those aspects are controlled by platoon controller 310. Corresponding information is received from the partner vehicle, regardless of whether those commands are generated by a platoon controller or other suitable controller on the partner vehicle (e.g., an adaptive cruise control system (ACC) or a collision mitigation system (CMS)), or through other or more traditional mechanisms—as for example, in response to driver inputs (e.g., accelerator pedal position, brake position, steering wheel position, etc.).

In many embodiments, much or all of the tractor sensor information provided to platoon controller 310 is also transmitted to the platoon partner and corresponding information is received from the platoon partner so the platoon controllers 310 on each vehicle can develop an accurate model of what the partner vehicle is doing. The same is true for any other relevant information that is provided to platoon controller 310, including any vehicle configuration information 390 that is relevant to platoon controller 310. It should be appreciated that the specific information transmitted may vary widely based on the requirements of platoon controllers 310, the sensors and actuators available on the respective vehicles, and the specific knowledge that each vehicle may have about itself.

The information transmitted between vehicles may also include information/data about intended future actions as will be discussed in greater detail below. For example, if the lead vehicle knows it is approaching a hill, it may expect to increase its torque request (or decrease its torque request in the context of a downhill) in the near future and that information can be conveyed to a rear vehicle for use as appropriate by the platoon controller 310. Of course, there is a wide variety of other information that can be used to foresee future torque or braking requests and that information can be conveyed in a variety of different forms. In some embodiments, the nature of the expected events themselves can be indicated (e.g., a hill, curve, or exit is approaching) together with the expected timing of such events. In other embodiments, the intended future actions can be reported in the context of expected control commands such as the expected torques and/or other control parameters and the timing at which such changes are expected. Of course, there are a wide variety of different types of expected events that may be relevant to the platoon control.

The communications between the vehicles and the NOC may be transmitted over a variety of different networks, such as a cellular network, various Wi-Fi networks, DSRC networks, satellite communications networks and/or any of a variety of other networks as appropriate. The communications with the NOC may be coordinated by NOC communications controller 380. The information transmitted to and/or received from the NOC may vary widely based on the overall system design. In some circumstances, the NOC may provide specific control parameters such as a target gap. These control parameters or constraints may be based on factors known at the NOC such as speed limits, the nature of the road/terrain (e.g., hilly vs. flat, winding vs. straight, etc.) weather conditions, traffic or road conditions, etc. In other circumstances the NOC may provide information such information to platoon controller 310. The NOC may also provide information about the partner vehicle including its configuration information and any known relevant information about its current operational state such as weight, trailer length, etc.

Lastly, with regard to FIG. 3, configuration file 390 may include a wide variety of information about the host vehicle that may be considered relevant to controller 310. By way of example, some of the information might include the vehicle's specification including such things as engine performance characteristics, available sensors, the existence and/or type of platooning indicators (e.g., lights that indicate a vehicle is platooning), the nature of its braking system, the location of its GNSS antenna relative to the front of the cab, gear ratios, differential ratios etc. In some embodiments, configuration file 390 may include information about a driver, a fleet, a fleet's schedule, a driver rating, a driver's ability to use the system, whether a vehicle has permission to use a system, whether a vehicle is certified to use the system, etc.

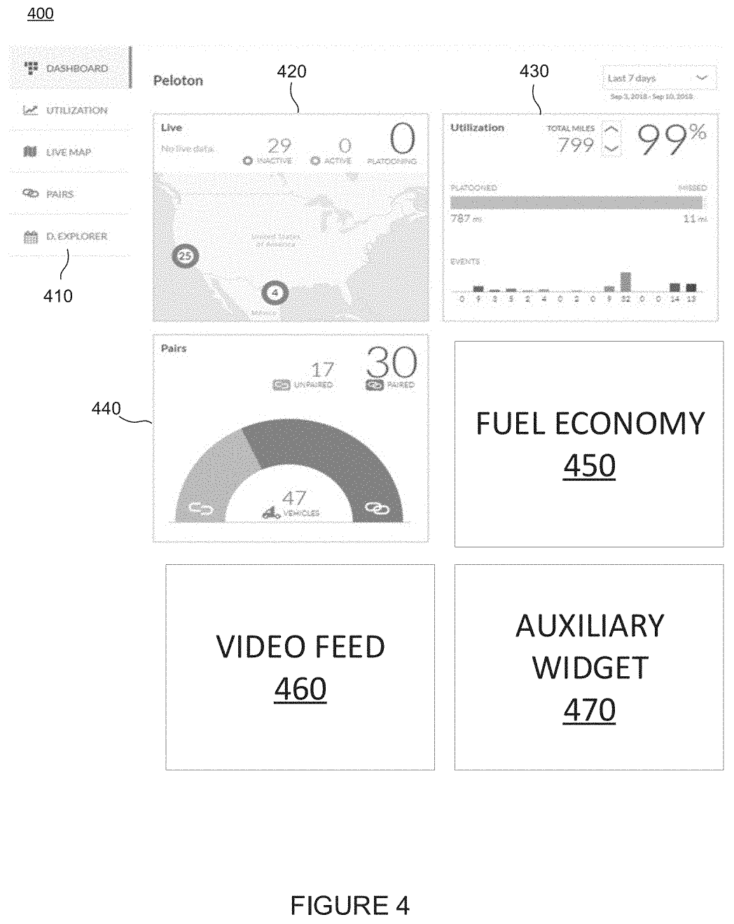

FIG. 4 illustrates an example dashboard 400, in accordance with some embodiments. Dashboard 400 includes a menu 410, and various widgets. As shown, the widgets include a map widget 420, a utilization widget 430, a pair status widget 440, a fuel economy widget 450, a video feed widget 460, and an auxiliary widget 470. In various embodiments, a dashboard may include more or fewer widgets.

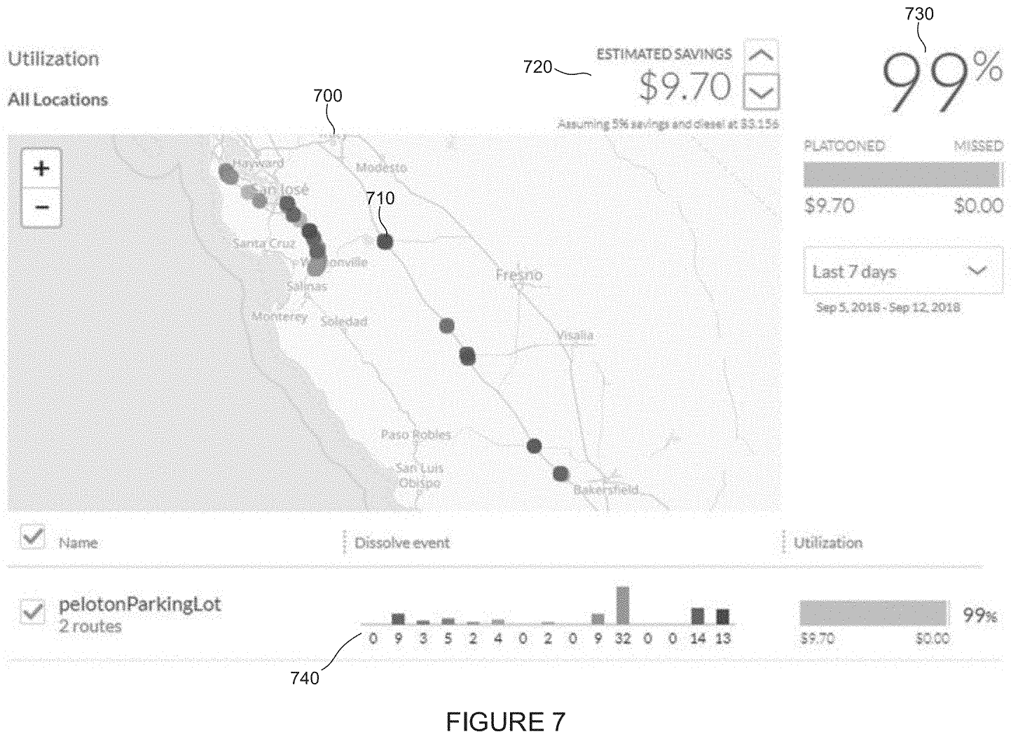

Menu 410 may enable a user to select a button which causes them to go to a webpage, web app, etc. Selecting an option in menu 410 may cause a widget to take up a larger portion of a screen (which may be based on screen attributes such as size and/or screen real estate). For example, clicking on a menu button that is associated with a widget (e.g., utilization) may cause at least a portion of the website to display a larger version of a utilization widget, or a utilization page (as shown in example FIG. 7). Similarly, selecting (e.g., clicking on) a widget may have the same functionality as selecting an option in menu 410. For example, clicking on map widget 420 may cause a webpage to display a larger map; clicking on fuel economy widget 450 may cause a webpage to display details associated with fuel economy that are not shown in fuel economy widget 450. In various embodiments a webpage other than dashboard 400 may include menu 410. Further, it should be understood that the terms web page, website, web service, and web app may be used interchangeably in this disclosure, and one of skill in the art should understand what is meant (e.g., they all display/provide the same or similar information, regardless of what they are called).

Map widget 420 may include a map and one or more symbols that may represent one or more vehicles. Map widget 420 may include information indicating a number of vehicles included in a system (e.g., a database that includes vehicles and associated attributes). Map widget 420 may indicate location(s) of one or more vehicles, an amount of vehicles that are active (e.g., vehicles that have communicated with the system (e.g., a NOC) within a threshold amount of time (e.g., 1 minute, 5 minutes). Map widget 420 may also show vehicles that are inactive, and vehicles that are platooning. In some embodiments, map widget 420 may display vehicles that are paired but not platooning, unpaired, etc.

Utilization widget 430 may display metrics associated with how vehicles are utilized. For example, utilization widget 430 may include information associated with one or more trucks, which may include distance traveled (e.g., within a time period), a percentage of a trip spent platooning, a distance spent platooning, various events that occurred during a trip, etc. For example, utilization widget 430 indicates that 99% of a 799-mile trip was spent platooning. Specifically, in this example, that 787 miles were spent platooning, and 11 miles were not spent platooning (e.g., missed). Further, the bottom of example utilization widget 430 indicates events that occurred along the trip. Events will be described in more detail later, but may include authorizations to platoon, deauthorizations from platooning, engaging a platoon, disengaging a platoon, being paired with another vehicle, being unpaired with another vehicle, platoon dissolves (e.g., the beginning of a platoon disengage wherein a gap is increased between the rear and front vehicles), draw-ins (e.g., the beginning of a platoon wherein a rear vehicle and a front vehicle reduce a gap to a desired distance/headway), cut-ins (e.g., wherein a vehicle moves between platooning vehicles, which in some cases may cause a dissolve), a proximity dissolve (e.g., wherein a vehicle in front of a front or rear vehicle begins decelerating and/or slows to an unsafe distance in front of the front vehicle), loss of cellular connection, etc.

Pair status widget 440 may indicate a number and/or percentage of paired vehicles. Paired vehicles may be vehicles that are authorized to platoon with each other (e.g., in some cases whether they are platooning or not). Pair status widget may also indicate a number and/or percentage of unpaired vehicles. In example pair status widget 440, out of a total of 47 vehicles, 30 are paired and 17 are unpaired.

Fuel economy widget 450 may indicate an attribute associated with a fleet and fuel economy. For example, fuel economy widget 450 (or another webpage/web app that displays fuel-related data) may indicate information including, but not limited to: how much fuel one or more vehicles (and/or one or more pairs of vehicles) in a fleet are saving (e.g., on average) by platooning, how much the cost of that fuel is/was/is estimated to be in the future/present/past, how a cost of fuel is determined, locations and their associated fuel prices, fuel vendors and their associated locations and/or fuel prices, fuel vendors and whether they accept COMDATA™ or another type of fuel card/discount program specific to vehicle/trucking fleets, how much fuel vehicles that are not platooning are using, whether fuel-related data is unavailable for one or more vehicles, etc.

Video feed widget 460 may provide information associated with one or more video feeds. Such information may include a list of available video feeds, a status of the vehicle in which the video recorder is located, a video feed itself, an option to allow video to be transmitted from a user of dashboard 400 to a vehicle (e.g., to a graphical user interface or other display included in a vehicle), etc.

In some embodiments, video feed widget 460 may be replicated on its own web page/web app—as with map widget 420, utilization widget 430, pair status widget 440, etc. Video feed widget may display images captured by a video camera of a view of the road ahead, images captured by a video camera on a rear vehicle (e.g., of a view of the rear of a front vehicle), images captured by a video camera on any vehicle of an interior of a cabin, images captured by a video camera on any vehicle of a rear, side, and/or undercarriage of a vehicle, etc. In some embodiments, a user of a remote terminal may use a terminal's camera to send video of themselves to a display within a vehicle, and/or be able to see the video of themselves that is being sent to a display within a vehicle on their own terminal.

Auxiliary widget 470 may provide a variety of other information about a vehicle, a fleet, platoons, events, authorizations, etc. In some embodiments, multiple auxiliary widgets may be added to systems and methods described herein. In some embodiments, new widgets may be developed and added to the system, and be displayed (sometimes automatically) on dashboard 400. In some embodiments, a user of a system may create their own auxiliary widget that includes information provided by a NOC, vehicle, or other source (e.g., the names of vehicles that are platooning, locations of dissolves, system faults).

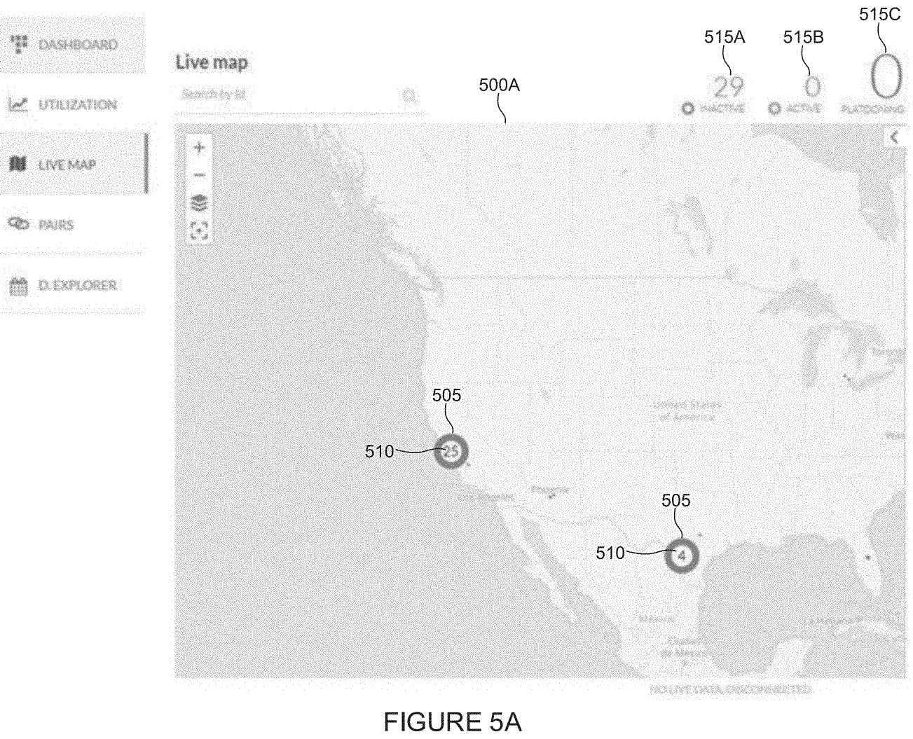

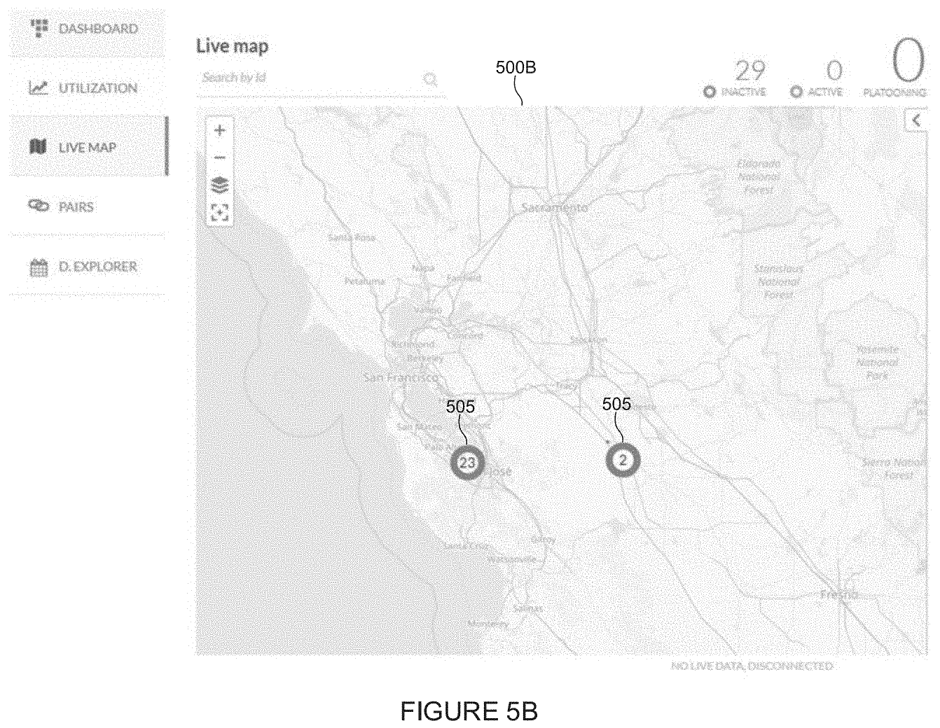

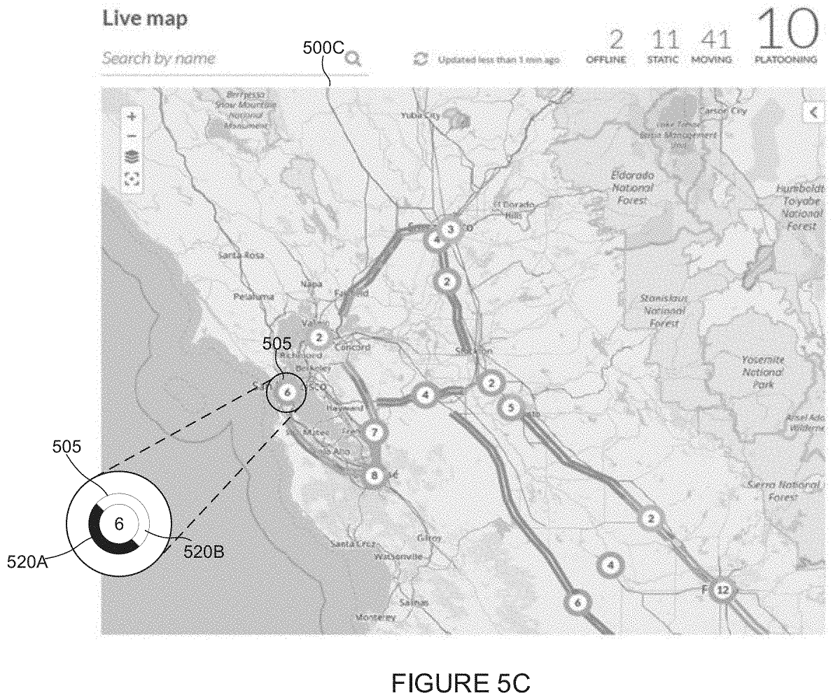

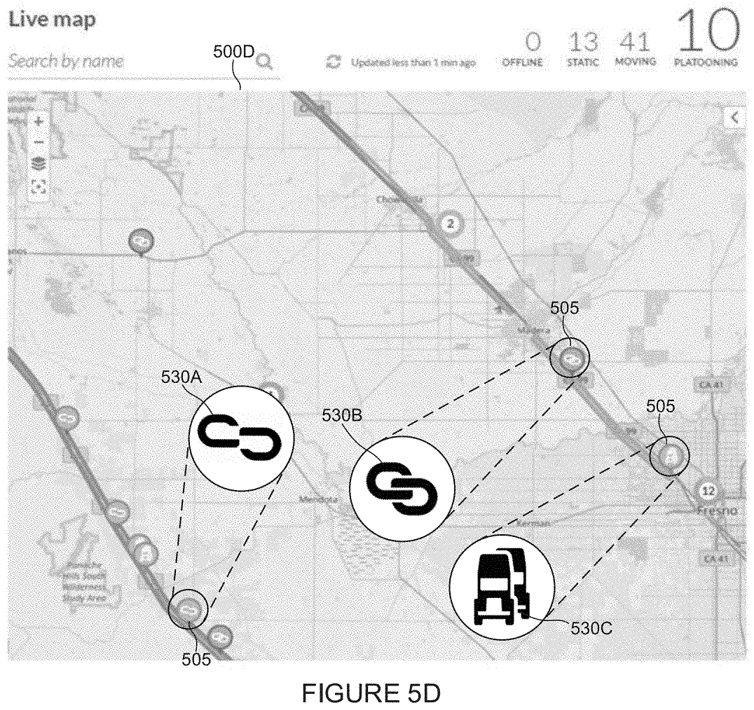

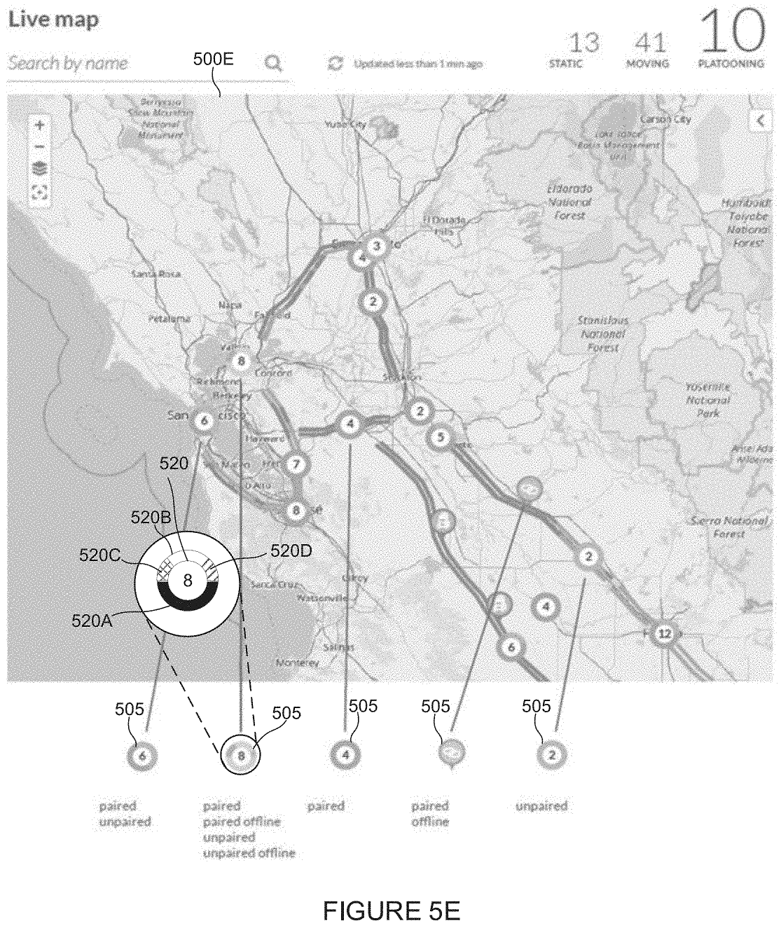

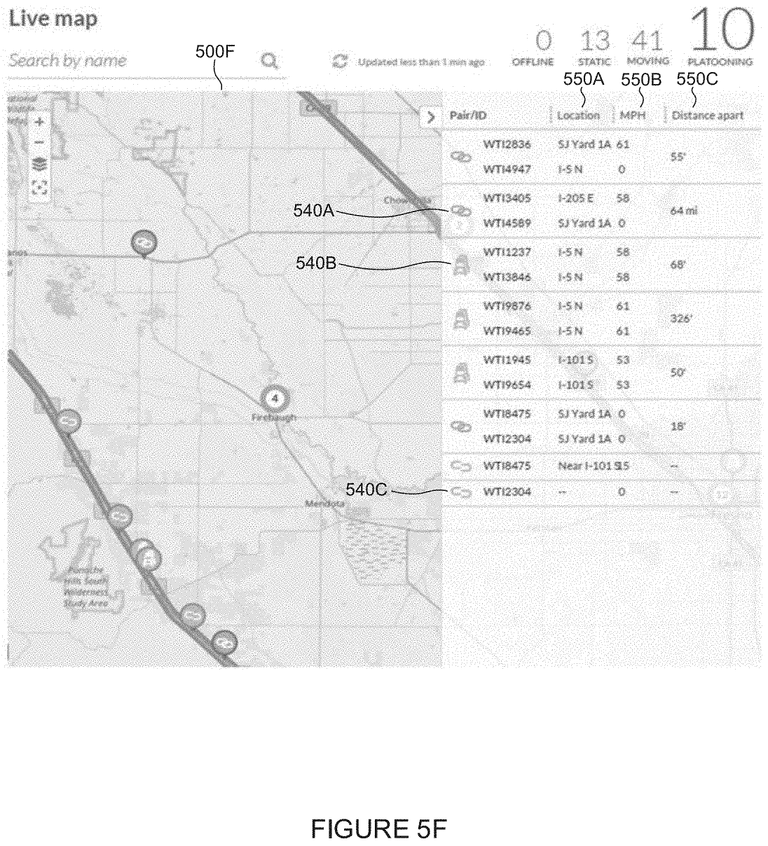

FIG. 5A illustrates an example map 500A, in accordance with some embodiments. FIG. 5A illustrates a webpage that includes a map 500A, which may include real-time and/or near-real-time information about vehicles associated with a system (e.g., included in a fleet). In some embodiments the vehicles represented in FIG. 5A may be platoonable vehicles, or a mix of platoonable vehicles and non-platoonable vehicles. In some instances, map 500A may also include automated/self-driving vehicles.

Map 500A includes symbols 505 which, in one example indicate that there are 25 vehicles near each other, and in another example indicate that there are 4 vehicles near each other. Within symbols 505 a number 510 is included that indicates a number of vehicles that are represented by symbols 505. In some embodiments, numbers 510 may indicate vehicles that are active (e.g., have communicated with the system within a threshold amount of time (e.g., 1 minute, 5 minutes, 30 minutes, 1 hour, 1 day) and/or inactive (e.g., vehicles that have not communicated with the system within a threshold amount of time).

In addition, FIG. 5A includes indicators 515A, 515B, and 515C which indicate how many vehicles are inactive, how many vehicles are active, and how many vehicles are platooning, respectively. In various embodiments, additional statistics may be included that are associated with map 500A but not displayed within map 500A.

FIG. 5B illustrates an example map 500B, in accordance with some embodiments. In various embodiments, a user may zoom in on a portion of a map which may cause a display to display information associated with vehicles with more granularity than map 500A. For instance, the example map 500B may be a zoomed-in version of map 500A, such that instead of indicating that 25 vehicles are located in Northern California, map 500A shows that 23 vehicles are located in California's Silicon Valley and 2 vehicles are located in California's Central Valley.

FIG. 5C illustrates an example map 500C, in accordance with some embodiments. Example map 500C may include symbols 505 as in maps 500A and 500B. Map 500C illustrates a blown-out symbol 505 for easier viewing of the drawings. In some embodiments, symbols 505 may include a symbol (e.g., a circle, a diamond, a square, a text box) that may indicate attributes associated with one or more vehicles. For example, a circle that includes a 6, wherein the circle is half one color 520A and half another color 520B, may indicate that symbol 505 represents 6 vehicles and that half of them are platooning. Of course, if only ⅓ of the circle in symbol 505 was one color and ⅔ of the circle were another color, then symbol 505 may indicate that ⅓ of the vehicles are platooning while ⅔ of the vehicles are not platooning. Of course, the colors within symbol 505 may indicate other attributes, such as whether vehicles are active, inactive, authorized to platoon, experiencing disruptions in service, having communication problems, having vehicle problems, etc.

FIG. 5D illustrates an example map 500D, in accordance with some embodiments. Map 500D includes symbols 505 which are blown-out for ease of view. Blown-out symbols 530A, 530B, and 530C all indicate various states at least one vehicle may be in. For instance, symbol 530A may indicate a vehicle that is not paired with another vehicle, symbol 530B may indicate a vehicle that is paired with another vehicle, and symbol 530C may indicate one or more vehicles that are platooning. In various embodiments, paired vehicles are vehicles that are associated with each other (e.g., wirelessly connected, such as via DSRC and/or a cellular network), such that they are able to engage into a platoon. In various embodiments, unpaired vehicles may be vehicles that are not communicating with one another (e.g., wirelessly connected, such as via DSRC and/or a cellular network).

FIG. 5E illustrates an example map 500E, in accordance with some embodiments. Map 500E includes symbols 505, which may indicate vehicles and their respective statuses. One blown-out symbol 520 includes multiple sections 520A, 520B, 520C, and 520D. In this example, symbol 520 can indicate that it represents 8 vehicles, four of which (represented by section 520A) have a first status, 2 of which (represented by section 520B) have a second status, 1 of which (represented by section 520C) has a third status, and 1 of which (represented by section 520D) has a fourth status. Of course, a first status, a second status, a third status, and/or a fourth status may include, but are not limited to: being active (e.g., online), being inactive (e.g., offline), being paired, being unpaired, and platooning. Further, more, or fewer vehicles may be represented by more, or fewer sections 520A, 520B, 520C, 520D, or other portions of a symbol (e.g., another shape and/or a text box) that indicate the status of one or more vehicles.

FIG. 5F illustrates an example map 500F, in accordance with some embodiments. In some embodiments, a transparent menu and/or status indicator may overlay map 500F (e.g., to conserve screen real estate—particularly if the display is included in an electronic logging device). Example map 500F includes a status indicator which displays the status of one or more vehicles (e.g., platooning vehicles 540B, paired vehicles 540A, unpaired vehicles 540C, active vehicles, and/or inactive vehicles). FIG. 5 also includes example vehicle statuses/attributes. These can include at least one vehicle's location 550A, speed 550B, and distance apart 550C. In some embodiments, a pair of vehicles and/or platooning vehicles may be flagged (e.g., turn a different color, cause a notification to appear) indicating that there is a fault. For example, a notification may appear on a display in response to statuses that indicate two vehicles are platooning but are 100 miles apart.

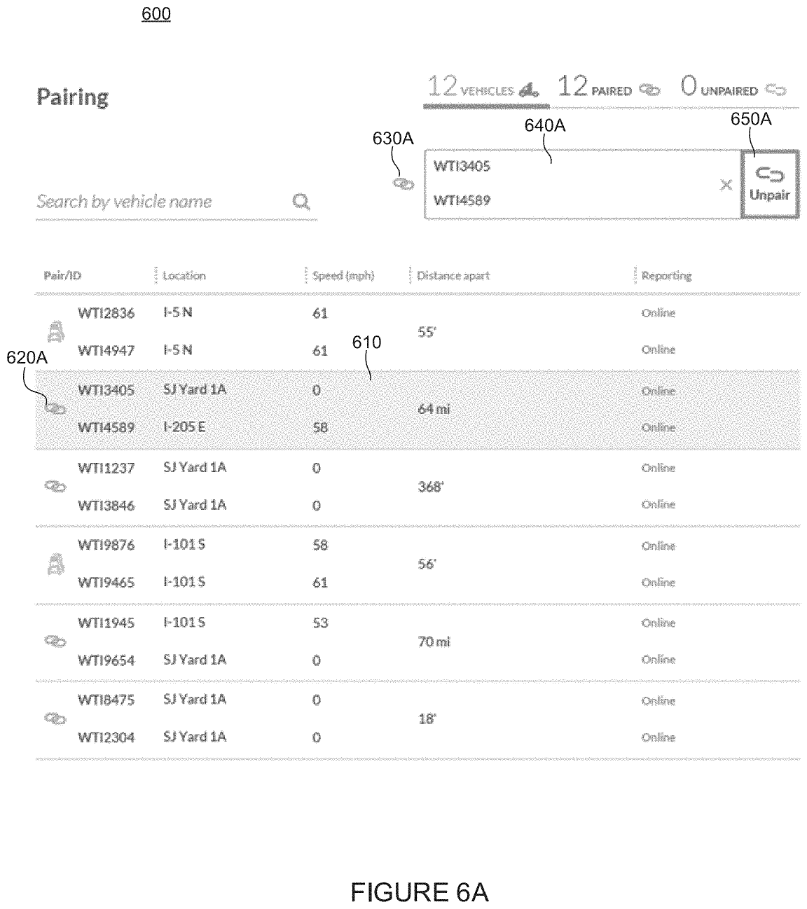

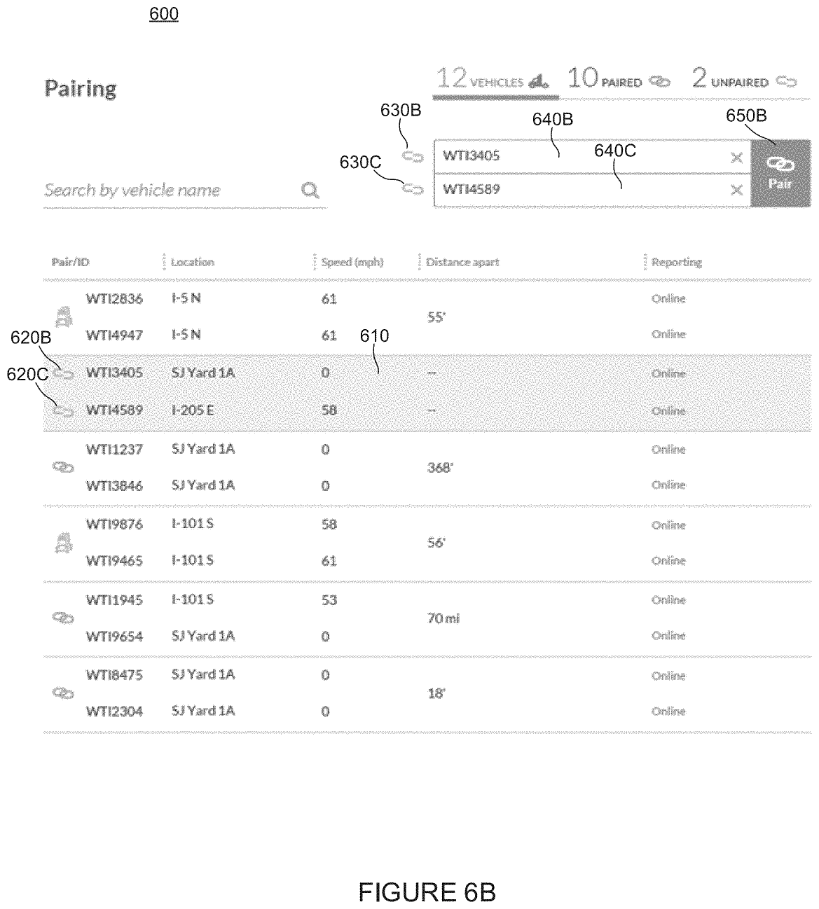

FIG. 6A illustrates example user interface 600, in accordance with some embodiments. User interface 600 includes a list of vehicles and statuses/attributes 620A associated with the vehicles. Some vehicles may be paired, as shown in block 610, where vehicles WTI3405 and WTI4589 are shown as paired. User interface 600 also includes a widget 640 which can allow a user to select one or more vehicles. In some examples selecting block 610 may populate widget 640A with one or more vehicles (e.g., representations of vehicles such as vehicle names). Widget 640A may also include and/or be adjacent to a symbol 630A that represents a status/attribute of one or more vehicles in widget 640A.

In some embodiments, user interface 600 may allow a user to cause one or more vehicles to change their statuses (e.g., to paired, unpaired, platooning, deactivating, activating). For example, user interface 600 may include a widget (e.g., a button 650A), or a portion of a widget (e.g., widget 640A) that allows a user to change the status/attributes of one or more vehicles. In this example, by clicking on block 610 paired vehicles WTI3405 and WTI4589 may populate widget 640A, and in response to pressing button 650A the two paired vehicles WTI3405 and WTI4589 may be unpaired. In various embodiments, vehicles may be selected using a plurality of methods via a user interface, and causing vehicles to change their statuses may be performed using a plurality of methods via a user interface.

FIG. 6B illustrates example user interface 600, in accordance with some embodiments. User interface 600 includes a list of vehicles and statuses/attributes 620B, 620C associated with the vehicles. In this example, 2 vehicles are unpaired—WTI3405 and WTI5489. User interface 600 also includes a widget that allows a user to select one or more vehicles 640B and 640C. Their respective statuses 630B and 630C may be shown within or near the widget, which may include a button 650B that allows a user to change the status of one or more vehicles. In example user interface 600, a user may select vehicles WTI3405 and WTI4589 by clicking on them, and then a user may pair them by clicking on button 650B.

FIG. 7 illustrates an example map 700 including symbols 710 that represent events, in accordance with some embodiments. FIG. 7 includes a user interface that includes information such as an estimated amount of money saved 720, information about how an estimated amount of money saved is calculated, an amount of platooning 730—which may be represented by cost savings, a percentage of a trip being paired, a percentage of a distance, a percentage of a trip, etc. In various embodiments a user interface may include a graphic 740 that may indicate events that occurred and a number of times various events occurred. Events may include, but are not limited to: engaging, disengaging, dissolving in response to a cut-in, pairing, unpairing, dissolving due to a vehicle in front of a front vehicle decelerating, losing or gaining a cellular signal/connection, losing or gaining a connection to a NOC, losing or gaining a connection to another vehicle, losing or gaining a video stream, and losing or gaining an audio communication.

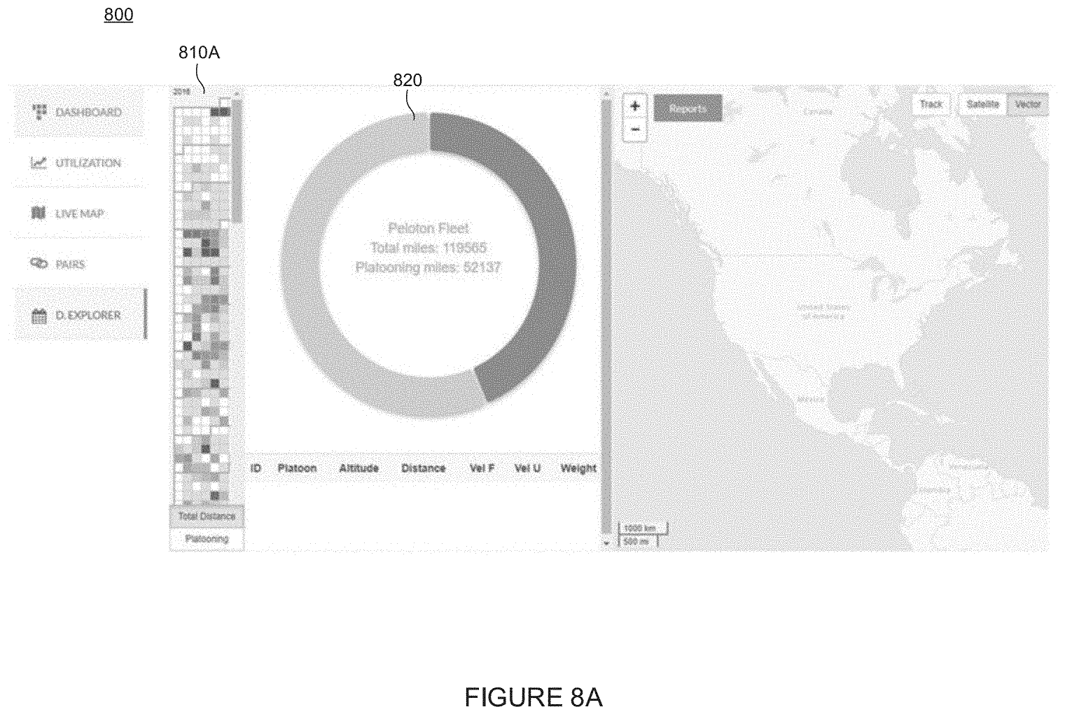

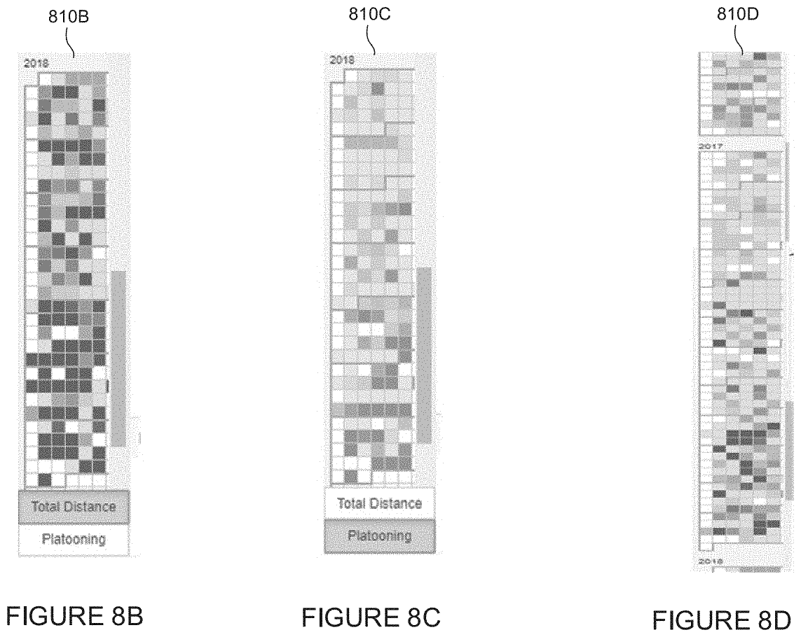

FIG. 8A illustrates an example user interface 800, in accordance with some embodiments. User interface 800 may include information about a fleet 820 (e.g., a distance a fleet has platooned and/or a distance a fleet traveled). User interface 800 may also include a calendar 810A. In response to selecting a date using calendar 810A or another widget a system may display information about vehicle attributes associated with a selected date. For example, by clicking on a square in 810A, information about how far a vehicle traveled on a selected date.

In some embodiments, various colors and/or shades of colors may represent information about one or more vehicles (e.g., a heatmap). For example, the shade of squares in calendar 810A may indicate that a threshold amount of platooning by one or more vehicles occurred on a day.

FIG. 8B illustrates an example user interface, in accordance with some embodiments. In example calendar 810B, in response to a distance button being selected, shades of squares may indicate that a threshold amount of distance was traveled by one or more vehicles.

FIG. 8C illustrates an example user interface, in accordance with some embodiments. In example calendar 810C, in response to a platooning button being selected, shades of squares may indicate that a threshold amount of platooning was performed by one or more vehicles.

FIG. 8D illustrates an example user interface, in accordance with some embodiments. In some embodiments, in order to display additional dates on in a calendar without increasing a size of a calendar (e.g., the amount of screen real estate a calendar uses), a user may provide input causing the calendar to zoom out, as shown in example calendar 810D.

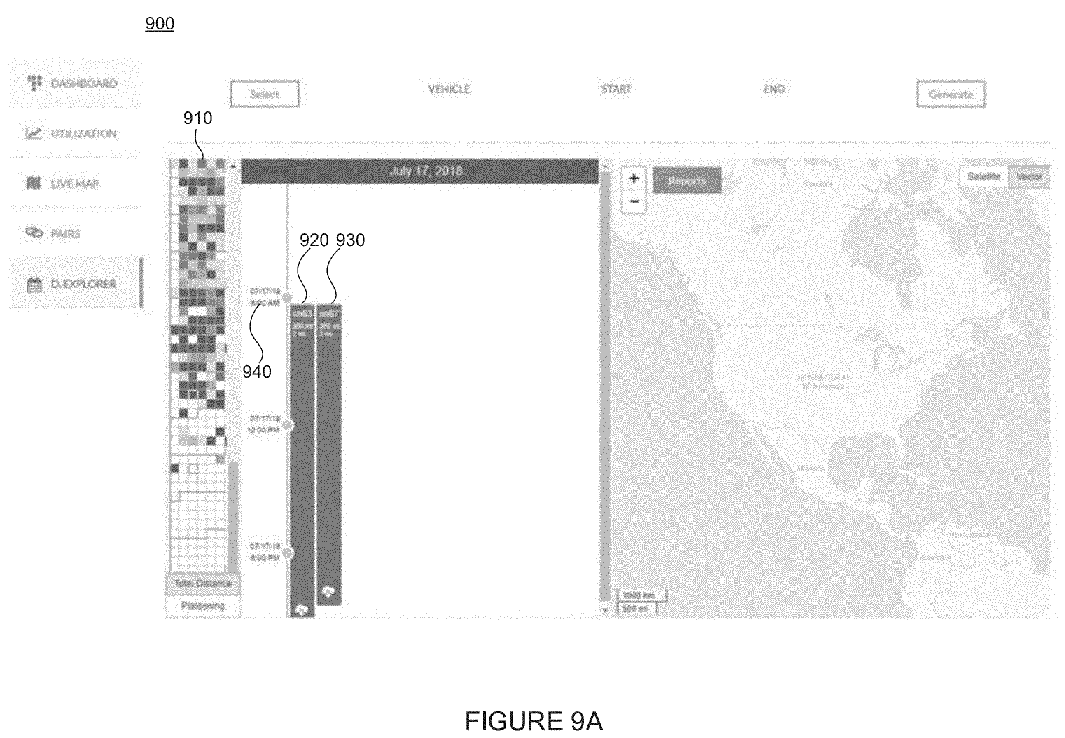

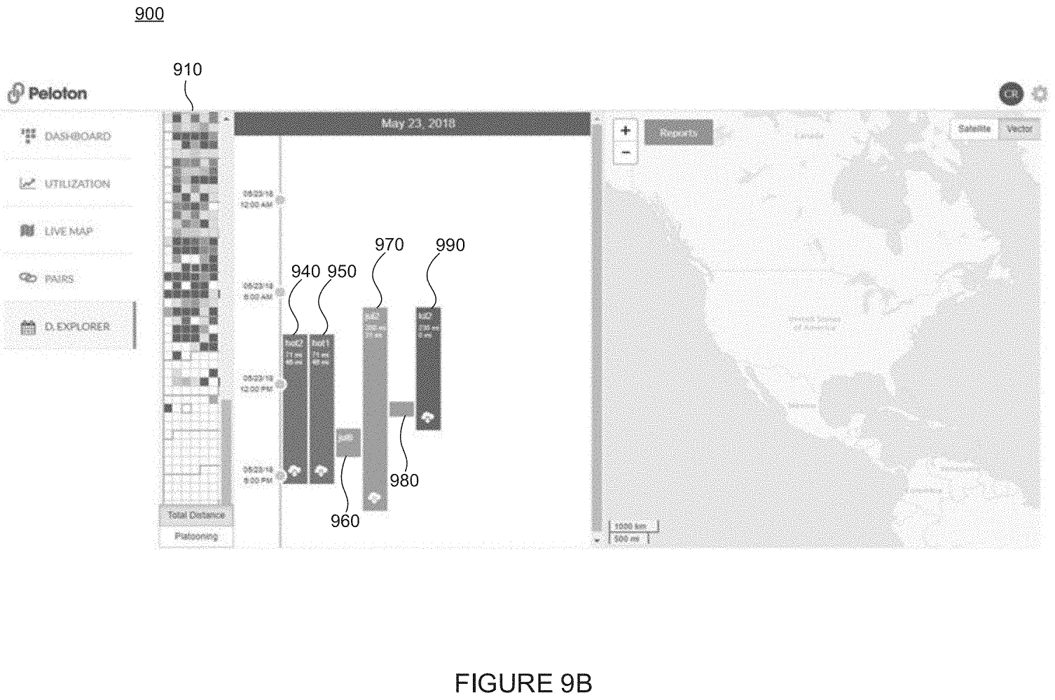

FIG. 9A illustrates an example user interface 900 of vehicle attributes, in accordance with some embodiments. FIG. 9A includes calendar 910, time and date 940, and symbols 920 and 930 that represent at least a portion of one or more trips by one or more vehicles. In one example, a user may select a date on calendar 910, and symbols 920 and 930 representing two vehicles that traveled from about 6:00 a.m. to about 6:00 p.m. on a particular date.

FIG. 9B illustrates an example user interface 900 including vehicle attributes, in accordance with some embodiments. Similar to calendar 810D in FIG. 8D, a user may zoom out and see a larger amount of information associated with one or more vehicles and/or one or more trips, which in FIG. 900 includes bars 940, 950, 960, 970, 980, and 990 that represent times and distances that vehicles traveled and/or platooned.

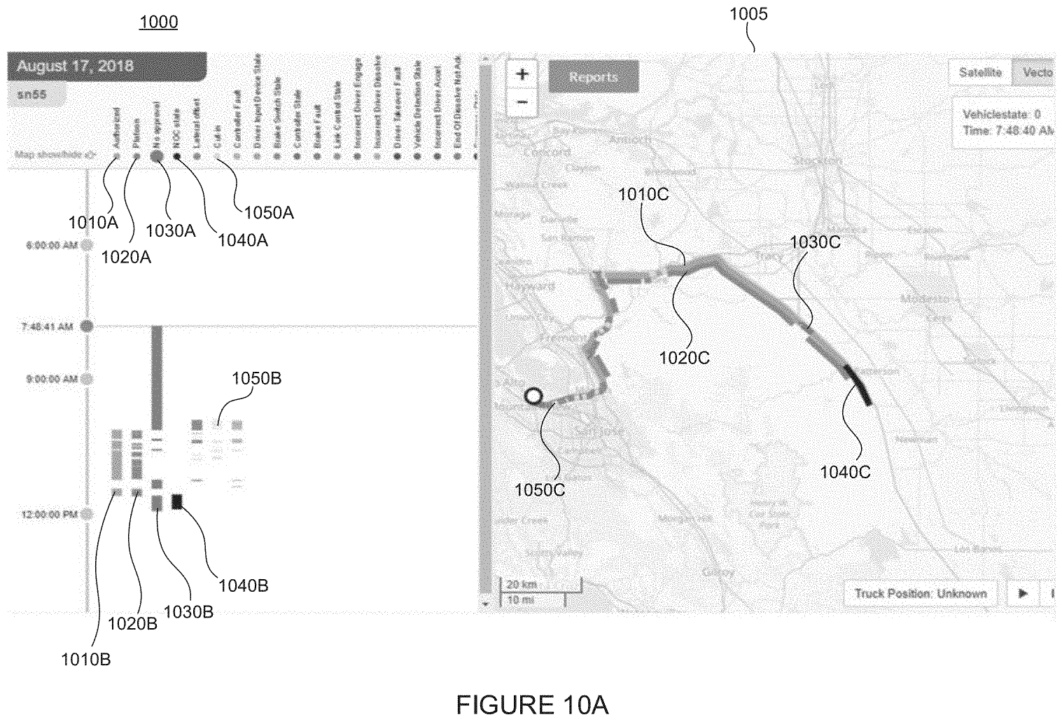

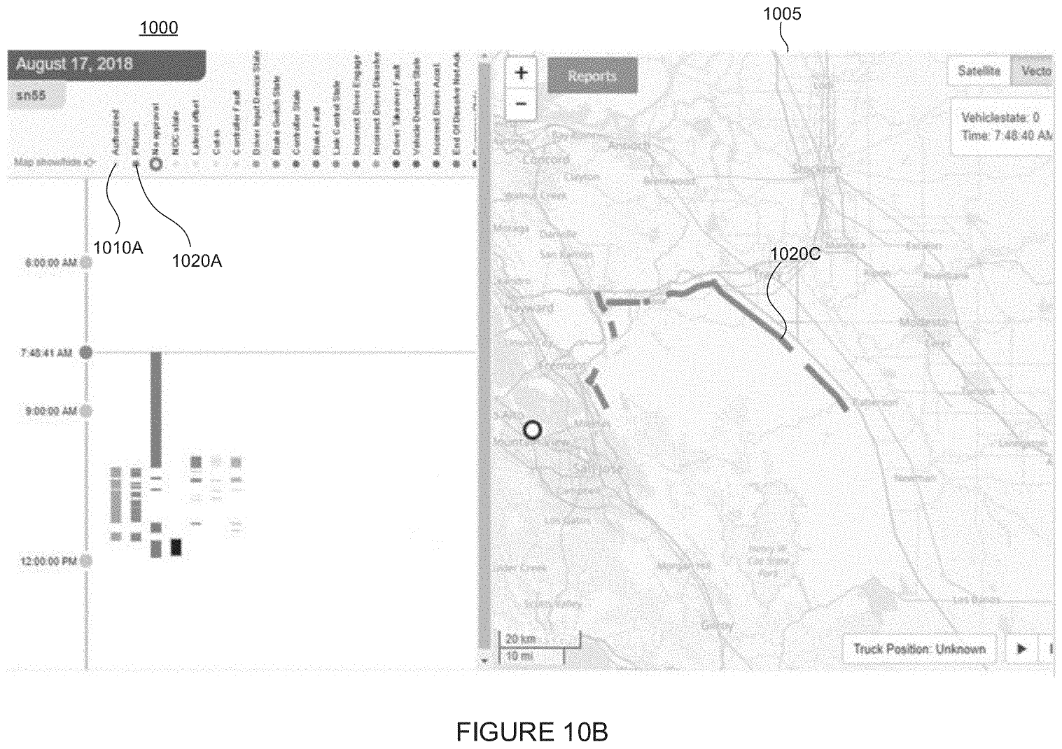

FIG. 10A illustrates an example user interface 1000 of vehicle attributes including a map 1005, in accordance with some embodiments. Example user interface 1000, may include information about one or more vehicles and indicate events and a time/amount of time that the events occurred. For example, events including whether a vehicle is authorized to platoon 1010A, whether a vehicle is platooning 1020A, whether a vehicle does not have approval to platoon 1030A, whether a vehicle is connected to a NOC 1040A, and whether a platoon dissolves in response to a cut-in 1050A are shown in FIG. 10. Event indicators (e.g., lines/bars) 1010B, 1020B, 1030B, 1040B, and 1050B may indicate what time events 1010A, 1020A, 1030A, 1040A, and 1050A occurred. Moreover, map 1005 may display one or more locations where events 1010C, 1020C, 1030C, 1040C, and 1050C occurred. Thus, as can be seen in FIG. 1000, events 1010A, 1020A, 1030A, 1040A, and 1050A may be represented by and/or correspond with event indicators 1010B, 1020B, 1030B, 1040B, and 1050B (which show times when the corresponding events occurred) and/or locations/location indicators 1010C, 1020C, 1030C, 1040C, and 1050C (which show locations where the corresponding events occurred).

In other words, in some embodiments, FIG. 10A illustrates map 1005 wherein multiple continuous states (e.g., events 1010C, 1020C, 1030C, 1040C, and 1050C) of one or more vehicles are depicted simultaneously on a single map along a single route (although it is contemplated more than one map could depict continuous states of vehicles that traveled on one or more routes). Next to this map (or on a separate display/widget/page), a visual representation of each state may be shown, which may allow a user to see what states occurred at what times (e.g., in parallel with the map), such that they may easily see each state when a map might not be as clear when showing multiple states.

FIG. 10B illustrates an example user interface 1000 of vehicle attributes including a map 1005, in accordance with some embodiments. In some embodiments, widgets (including buttons) may be selected that cause one or more location indicators on a map to be displayed and/or stop being displayed. For example, in FIG. 10B button 1010A was/was not selected such that the locations where a vehicle was authorized platoon are not displayed. Similarly, button 1020A may be/not be selected such that locations where a vehicle was platooning 1020C are displayed on map 1005.

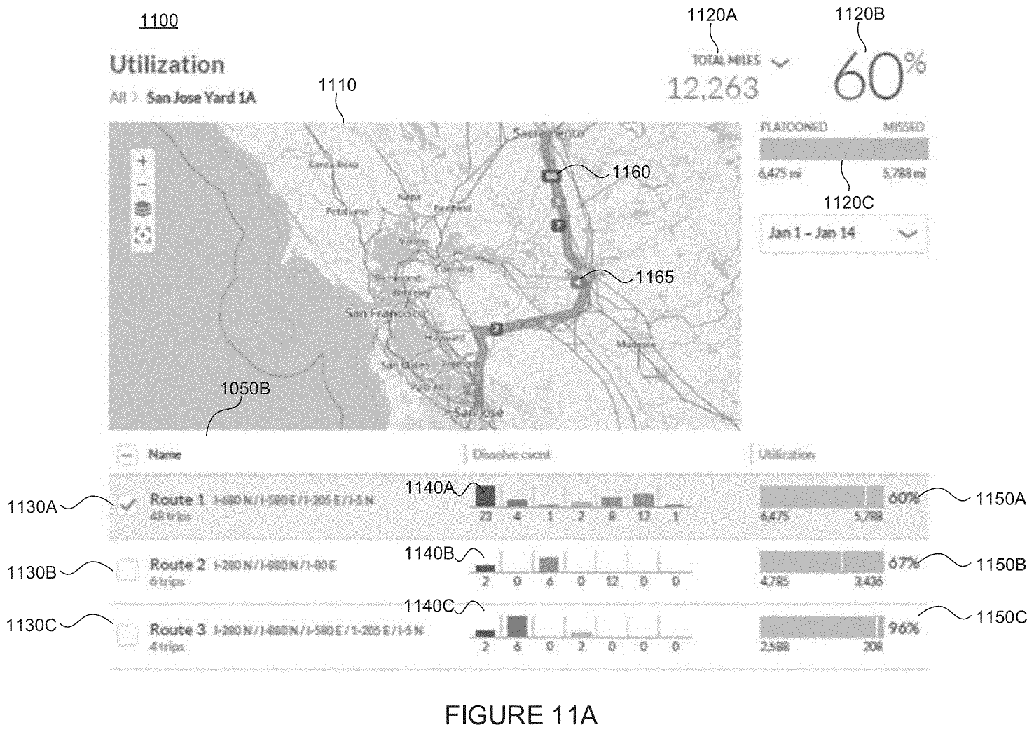

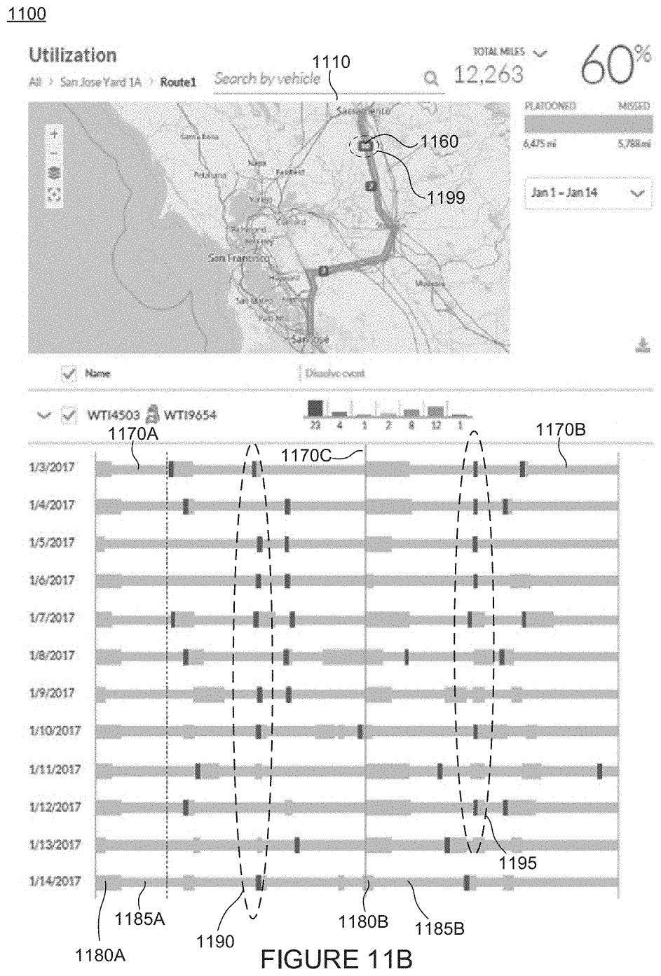

FIG. 11A illustrates an example user interface 1100 of vehicle attributes, in accordance with some embodiments. User interface 1100 includes a map 1110, information including an amount of distance traveled 1120A, a percentage of a trip platooned 1120B, and a graphic indicating an amount of distance traveled and platooned 1120C. In addition, information associated with a plurality of routes 1130A, 1130B, and 1130C are displayed. This information may include information about events (e.g., dissolves) 1140A, 1140B, and 1140C, and information about platooning utilization 1150A, 1150B, and 1150C.

User interface 1100 indicates that the information provided about Route 1 1130A was based on data collected over the course of 48 trips that took Interstate 680 North to Interstate 580 East to Interstate 205 East to Interstate 5 North. Along those trips, dissolve events 1140A are shown which include 23 cut-ins, 4 losses of service, etc. In addition, along those trips, 60% of the distance traveled was spent platooning (e.g., 6,475 miles) as shown by utilization indicator 1150A.

Between example routes 1, 2, and 3, utilization indicators 1150A, 1150B, and 1150C show that Route 3 included the fewest dissolves, and the highest percentage of the trips platooning (e.g., 96%). In various embodiments, a notification or other indicator may recommend that vehicles travel on route 3 in response to a percentage of trips spent platooning being the highest of two or more routes. Of course, a route may be recommended based on many factors, alone or in combination, including, but not limited to: fuel savings, a location, a distance of a route, a percentage of time platooning, an amount of time, etc.

FIG. 11B illustrates an example user interface 1100 of vehicle attributes, in accordance with some embodiments. FIG. 11B includes a map 1100 which indicates locations where events occurred 1160. In some embodiments, information about multiple trips where vehicles were platooning may be shown. For example, line 1170A may indicate a trip to a location on Jan. 3, 2017, line 1170C may indicate a half way point, and line 1170B may indicate a trip back from the location traveled to on Jan. 3, 2017. In some embodiments, a line may be thicker or thinner to indicate whether a vehicle is platooning. Of course, other symbols may be used such as a circle, a text box, etc. In this example, line portions 1180A and 1180B indicate portions of a trip on Jan. 14, 2017 where a vehicle was not platooning, and line portions 1185A and 1185B indicate a portions of the trip where a vehicle was platooning. In some embodiments, indicators of events causing dissolves 1190 and 1195 may be displayed (e.g., events that cause an end to line portions 1170A, 1170B, 1185A, and 1185B).

In some embodiments, map 1110 may also indicate a location where events that caused dissolves occurred 1160. In this example, location 1160 may correspond with indicators of events causing dissolves 1190 and 1195. Based on this information (or any other type of historical information), in some embodiments, a geofence 1199 may be created by a system and/or a user of a terminal. For example, a geofence that prevents platoonable vehicles from platooning may be created surrounding an area such as 1160 (e.g., where many events causing dissolves occur). By creating this geofence, vehicles are less likely to be forced to dissolve by cut-ins, for example.

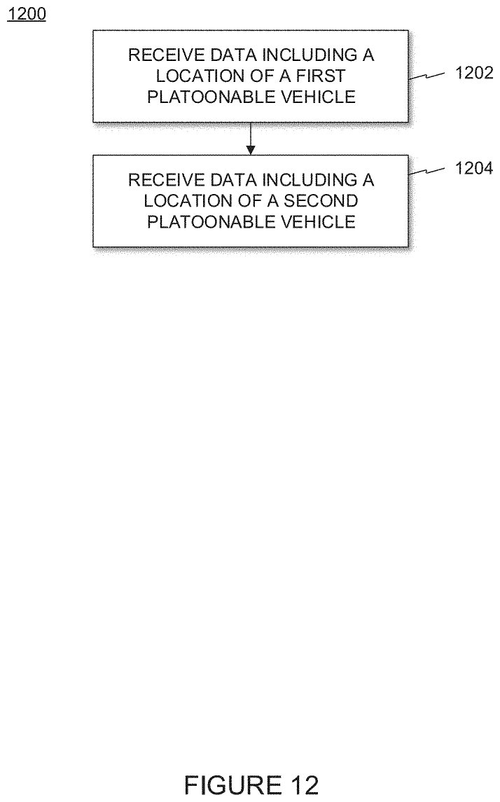

FIG. 12 illustrates a flowchart of an example process, in accordance with some embodiments. Example process 1200 includes a method for determining a time for a platoonable vehicle to travel on one or more roads, in accordance with various embodiments. While the various steps in the flowchart is presented and described sequentially, one of ordinary skill will appreciate that some or all of the steps can be executed in different orders and some or all of the steps can be executed in parallel. Further, in one or more embodiments of the invention, one or more of the steps can be omitted, repeated, and/or performed in a different order. Accordingly, the specific arrangement of steps shown in FIG. 12 should not be construed as limiting the scope of the invention. In one or more embodiments, the steps of FIG. 12 can be performed by example systems 100, 200, 300, and/or computing system 1300.

In step 1202, data is received including a location of a first platoonable vehicle. This data may be received at a terminal (e.g., via a NOC), from the first platoonable vehicle.

In step 1204, data is received including a location of a second platoonable vehicle. This data may be received at a terminal (e.g., via a NOC), from the second platoonable vehicle. In various embodiments, a remote terminal may display information about the first platoonable vehicle and/or the second platoonable vehicle (and/or at least one non-platoonable vehicle), such as the information included in FIGS. 4-11B. The remote terminal may be a computer, an electronic logging device, a laptop, etc.

Information about a first platoonable vehicle and/or a second platoonable vehicle may include, but is not limited to: a distance traveled, a distance platooned, a distance/time/location traveled being paired, a distance/time/location traveled not being paired, a distance/time/location traveled while being authorized to platoon, a distance/time/location traveled while not being authorized to platoon, a distance/time/location while platooning, a distance/time/location while not platooning, etc.

Other information about a vehicle that may be displayed on systems described herein may include, but is not limited to a/an: position, latitude, longitude, altitude, heading, speed, longitudinal and lateral acceleration, relative angle, type of load (e.g., type of materials a vehicle is carrying), brake status, brake pressure, path history, path projection, travel plans, vehicle size, vehicle type, brake type, current operating mode (autonomous or manual), map data, traffic information, GPS augmentation information (e.g., delays from infrastructure), wheel speed, wheel torque, gross torque, net torque, wind, rain, music, video, infotainment system, suspension, axle weight(s), transmission status (e.g., what gear the vehicle is in, what gear the vehicle was in, what gears the vehicle transferred from and to (e.g., fifth gear to fourth gear)), previous transmission status, hybrid vehicle drivetrain (e.g., a parallel hybrid or an electric hybrid), electric motor, battery, super charger, electronic throttle control, throttle pedal, brake pedal, power steering, adaptive cruise control, a blowout, interior lighting, exterior lighting, retarder, anti-lock brakes, emergency braking, engine governor, powertrain, gear ratio, wheel size, wheel type, trailer length, trailer type, trailer height, amount of trailers, trailer position, current trailer position, past trailer position, tractor type, tractor height, transceiver type, current fuel, next determined stop, projected miles remaining until fuel tanks are empty, malfunctions, turn signals, LIDAR, radar, ultrasonic sensors, road surface, wheel angle, tire pressure, tire tread depth, cabin temperature, engine temperature, trailer interior temperature, camera, fleet of vehicles, NOC, computer vision, other vehicle traveling in the same direction, other vehicle traveling in an opposite direction, and intervening traffic (e.g., cut-ins, also referred to as the situation when a vehicle enters an area between a lead vehicle and a rear vehicle).

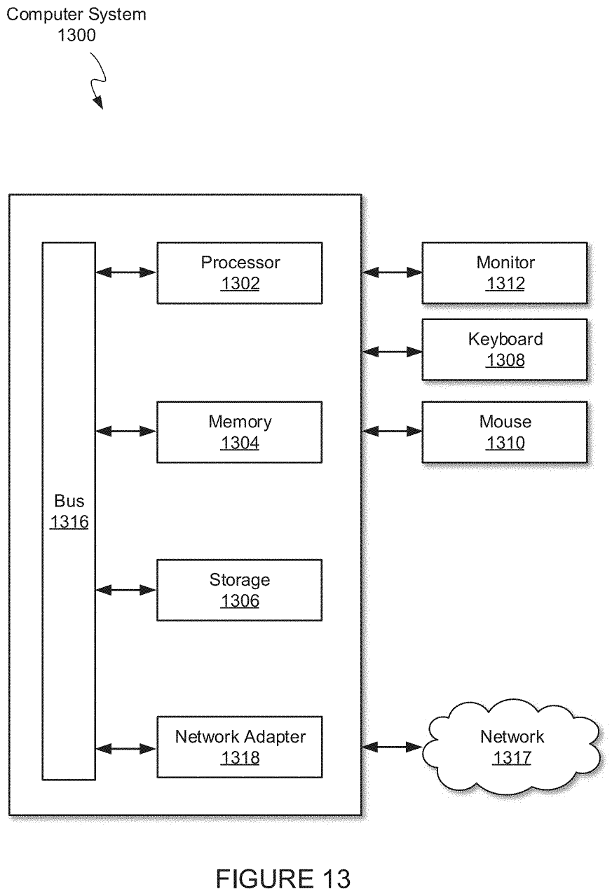

FIG. 13 illustrates an example computing system, in accordance with some embodiments.

In various embodiments, the calculations performed above may be discussed in the general context of computer-executable instructions residing on some form of computer-readable storage medium, such as program modules, executed by one or more computers or other devices. By way of example, and not limitation, computer-readable storage media may comprise non-transitory computer-readable storage media and communication media; non-transitory computer-readable media include all computer-readable media except for a transitory, propagating signal. Generally, program modules include routines, programs, objects, components, data structures, etc., that perform particular tasks or implement particular abstract data types. The functionality of the program modules may be combined or distributed as desired in various embodiments.

This disclosure contains numerous references to a NOC and to one or more processors. According to various aspects, each of these items may include various kinds of memory, including non-volatile memory, to store one or more programs containing instructions for performing various aspects disclosed herein.

For example, as shown in FIG. 13, example computing system 1300 may include one or more computer processor(s) 1302, associated memory 1304 (e.g., random access memory (RAM), cache memory, flash memory, read only memory (ROM), electrically erasable programmable ROM (EEPROM), or any other medium that can be used to store the desired information and that can be accessed to retrieve that information, etc.), one or more storage device(s) 1306 (e.g., a hard disk, a magnetic storage medium, an optical drive such as a compact disk (CD) drive or digital versatile disk (DVD) drive, a flash memory stick, etc.), and numerous other elements and functionalities. The computer processor(s) 1302 may be an integrated circuit for processing instructions. For example, the computer processor(s) may be one or more cores or micro-cores of a processor. The computing system 1300 may also include one or more input device(s) 1310, such as a touchscreen, keyboard, mouse, microphone, touchpad, electronic pen, or any other type of input device. Further, the computing system 1300 may include one or more output device(s) 1308, such as a screen (e.g., a liquid crystal display (LCD), a plasma display, touchscreen, cathode ray tube (CRT) monitor, projector, or other display device), a printer, external storage, or any other output device. The computing system 1300 may be connected to a network 1314 (e.g., a local area network (LAN), a wide area network (WAN) such as the Internet, mobile network, or any other type of network) via a network interface connection 1318. The input and output device(s) may be locally or remotely connected (e.g., via the network 1312) to the computer processor(s) 1302, memory 1304, and storage device(s) 1306.

One or more elements of the aforementioned computing system 1300 may be located at a remote location and connected to the other elements over a network 1314. Further, embodiments of the invention may be implemented on a distributed system having a plurality of nodes, where each portion of the invention may be located on a subset of nodes within the distributed system. In one embodiment of the invention, the node corresponds to a distinct computing device. Alternatively, the node may correspond to a computer processor with associated physical memory. The node may alternatively correspond to a computer processor or micro-core of a computer processor with shared memory and/or resources.

For example, one or more of the software modules disclosed herein may be implemented in a cloud computing environment. Cloud computing environments may provide various services and applications via the Internet (e.g., the NOC). These cloud-based services (e.g., software as a service, platform as a service, infrastructure as a service, etc.) may be accessible through a Web browser or other remote interface.

Communication media can embody computer-executable instructions, data structures, and program modules, and includes any information delivery media. By way of example, and not limitation, communication media includes wired media such as a wired network or direct-wired connection, and wireless media such as acoustic, radio frequency (RF), infrared, and other wireless media. Combinations of any of the above can also be included within the scope of computer-readable media.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered as examples because many other architectures can be implemented to achieve the same functionality.

The embodiments disclosed herein may also be implemented using software modules that perform certain tasks. These software modules may include script, batch, or other executable files that may be stored on a computer-readable storage medium or in a computing system. These software modules may configure a computing system to perform one or more of the example embodiments disclosed herein. One or more of the software modules disclosed herein may be implemented in a cloud computing environment.

While this disclosure has been described in terms of several aspects, there are alterations, modifications, permutations, and equivalents which fall within the scope of this disclosure. In view of the many alternative ways of implementing the methods and apparatuses of the present disclosure, it is intended that the following appended claims be interpreted to include all such alterations, modifications, permutations, and substitute equivalents as falling within the true scope of the present disclosure.

What is claimed is:

1. A method for displaying information about platoonable vehicles comprising:
receiving, at an electronic device, a location of a platoonable vehicle, wherein the location is received from the platoonable vehicle, and wherein the electronic device causes a display to display information about the platoonable vehicle.

2. The method of claim 1, wherein the information also includes a distance that the platoonable vehicle has traveled, and a distance that the platoonable vehicle has platooned.

3. The method of claim 2, wherein the information also includes information about miles traveled and an amount of fuel used and/or saved while platooning.

4. The method of claim 2, wherein the information also includes an estimated amount of money saved by platooning.

5. The method of claim 1, wherein the electronic device further causes the display to display one or more of: a map including information indicating the distance that the platoonable vehicle has traveled, a route that the platoonable vehicle has traveled, a distance that the platoonable vehicle has platooned, and a route that the platoonable vehicle has traveled.

6. The method of claim 5, wherein a user can cause the map to include or exclude the information indicating the route that the platoonable vehicle traveled.

7. The method of claim 6, wherein excluding the information indicating the route that the platoonable vehicle traveled causes the information indicating the route that the platoonable vehicle traveled to be displayed more prominently.

8. The method of claim 5, further comprising:
causing the display of the map to include information indicating a location of one or more of: (1) an area wherein the platoonable vehicle could not communicate with the electronic device; (2) an area where a cut-in occurred; and (3) an area where a dissolve occurred.

9. The method of claim 1, wherein the electronic device also displays information indicating an amount of vehicles that are not paired, an amount of vehicles that are paired, and an amount of vehicles that are platooning.

10. The method of claim 1, wherein the displayed information about the platoonable vehicle indicates when the platoonable vehicle was platooning on a route, and when the platoonable vehicle was paired with another platoonable vehicle and traveling on the route but not platooning.

11. The method of claim 1, wherein the displayed information about the platoonable vehicle also indicates a dissolve location, wherein the dissolve location is a location where a dissolve occurred at least a threshold number of times or fraction of times the platoonable vehicle was platooning on the route.

12. The method of claim 11, wherein the electronic device creates at least a portion of a geofence comprising the dissolve location, wherein the geofence prevents the platoonable vehicle from platooning within the geofence.

13. The method of claim 11, wherein a user causes the electronic device to create at least a portion of a geofence, wherein the geofence prevents the platoonable vehicle from platooning within the geofence.

14. The method of claim 1, wherein the electronic device causing the display to display information about the platoonable vehicle is based on a selection of a date.

15. A system for displaying platooning information, comprising:
a network operations center (NOC) comprising:
a processor; and
a memory;
wherein the NOC receives a first location from a first platoonable vehicle and a second location from a second platoonable vehicle, wherein the NOC causes a display to display information about the first platoonable vehicle and the second platoonable vehicle, and wherein the information indicates a route that the first platoonable vehicle and the second platoonable vehicle have traveled.

16. The system of claim 15, wherein the information also includes an estimated amount of money saved by platooning.

17. The system of claim 15, wherein the information also includes a distance that the first platoonable vehicle has traveled, and a distance that the first platoonable vehicle has platooned.

18. The system of claim 15, wherein the NOC receives information that causes the NOC to authorize the first platoonable vehicle and the second platoonable vehicle to platoon.

19. The system of claim 15, wherein the NOC receives information from a user that causes the NOC to authorize the first platoonable vehicle and the second platoonable vehicle to platoon.

20. A method for providing information about a platoon of vehicles, comprising:
receiving, at an electronic device, location information from at least one vehicle, wherein the location information includes a current location of the at least one vehicle;
receiving, at the electronic device, route information from the at least one vehicle, wherein the route information includes a route that the at least one vehicle as traveled, and wherein the at least one vehicle has platooned on at least a portion of the route; and
causing to be displayed, by the electronic device:
a map comprising information indicating where the at least one vehicle platooned on the route; and
an estimated amount of money saved by platooning.
